(19) United States
(12) Patent Application Publication
(10) Pub. No.: US 2011/0047459 A1
(43) Pub. Date: Feb. 24, 2011

(54) USER INTERFACE

(76) Inventor: Willem Morkel Van Der Westhuizen, Stellenbosch (ZA)

Correspondence Address: HAHN AND MOODLEY, LLP, 3333 Bowers Avenue, Suite 130, Santa Clara, CA, 95054, US

(21) Appl. No.: 12/682,091

(22) PCT Filed: Oct. 8, 2008
(86) PCT No.: PCT/ZA08/00090

§ 371 Date: Nov. 9, 2010

Related U.S. Application Data
(60) Provisional application No. 60/978,327, filed on Oct. 8, 2007.

(51) Int. Cl. G06F 3/048; G06F 3/041; G06F 3/01

(52) U.S. Cl. 715/702; 345/173; 715/773

(57) ABSTRACT

The invention provides a user interface for a data processing machine which user interface is combined with a primary display screen for the machine or which is configured to be used with a machine which usually includes a primary display screen, which user interface comprises a secondary touch-sensitive display screen which is configured to be an input device for the machine and configured such that the graphic display of the input device is configured to complement and operatively cooperate with the graphic display of the primary display screen.

### TECHNICAL FIELD OF THE INVENTION

This invention relates to a user interface and a data processing machine incorporating the user interface.

### BACKGROUND TO THE INVENTION

The applicant is aware of displays incorporated into a keyboard housing as described in U.S. Pat. Nos. 6,630,895 and 7,227,535, which use is limited to primary or secondary displays and which have not yet found mainstream acceptance.

The applicant is further aware of many user interfaces for data processing machines such as personal computers, note book computers, laptops, tablet PC's, PDA's and the like, which attempt to replace the standard QWERTY keyboard and/or mouse pointing device. One driver for the development of different types of user interfaces such as the multi-touch-sensitive screens operable by a person's hand or a tip of a pen is miniaturisation. It is an object of these developers to combine the display and the user interface to reduce the bulk of the device. It appears that a further driver for the development of user interfaces is to replace the mouse as a peripheral pointing device. The touch-sensitive pad combined with “clickable buttons” has been successful to some extent in laptop type personal computers however, a large number of persons still prefer to use a mouse when they are at the office, for example, even when on the move, despite the effort of carrying and plugging in the peripheral mouse. Miniaturised mouse with retractable cables have been developed for mobile use. The touch-sensitive pad is not user friendly for accurate or pinpoint applications and has not found mainstream acceptance as is evident from their lack of use for normal desktop type computers. Certain applications for personal computers require pinpoint accurate pointing or were developed with traditional keyboard and mouse interface devices in mind and work well with these traditional devices. The applicant believes further that the lack of tactile response from a touch-sensitive pad or touch screen adds to the resistance to mainstream acceptance as is evident from attempts to overcome this by the invention for a “display actuator” described in European Patent application EP1691263 and a “Movable Display” described in British patent application GB2423135. A further problem with touch-sensitive pads or screens is accidental or non intended touching of the screen which may lead to unintended results. This problem is addressed by US patent application 20070182722 by installing sensors for sensing the position of person's hands and to lock the touch pad which is situated below the normal keyboard when the user's hands are in a position to type on the keyboard. Another problem of using multi-touch-sensitive screens as input devices or user interfaces for tablet PC's, PDA's, cellular phones and the like devices is the soiling of the screen by physically touching the screen. However, apart from the above highlighted problems, the main disadvantage identified by the applicant of using multi-touch-sensitive screens as input devices or user interfaces for tablet PC's, PDA's, cellular phones and the like devices is the inescapable problem of obstructing part of the display by a users' hand or hands.

The applicant is further aware of a keyboard housing that incorporates a touch-sensitive display, as described in U.S. Pat. No. 6,396,483, which display can be used in different modes, a secondary display, virtual mouse or a numerical keypad, in which case numerical keypad buttons are displayed on the display. Although this invention provides the versatility of selecting between different input or pointing devices or a display, the individual input or pointing devices, once selected, is similar to a known usual input or pointing device with the same problems for touch pads as described above.

It is an object of this invention to provide a user interface which overcomes at least to some extent the above highlighted problems of known user interfaces and in particular the main highlighted problem above for laptop and desktop type personal computers, although the invention can be applied to most data processing machines incorporating the user interface and a display.

### GENERAL DESCRIPTION OF THE INVENTION

According to a first aspect of the invention there is provided a user interface for a data processing machine which user interface is combined with a usual display screen for the machine or which is configured to be used with a machine which usually includes a usual display screen, which user interface comprises:
a touch-sensitive display screen which is configured to be an input device for the machine and configured such that the graphic display of the input device is configured to complement and operatively cooperate with the graphic display of the usual display screen.

The touch-sensitive display screen may preferably be a multi-touch-sensitive display screen.

For ease of reading this specification the usual display screen used by all data processing machines will be referred to as a primary display screen and the display of the user interface in accordance with the invention will be referred to as a secondary display or secondary display input device depending on the context in which the user interface is referred to.

It will be understood that the term complement means that the separate complementing components when combined forms a single coherent entity, or that it is clear to a person skilled in the art that the primary and secondary displays are graphically related. Apart from the apparent advantages, it will be appreciated that an important advantage of the complementing displays is that the usual graphics display processor of a data processing machine can be adapted by means of driver software to display on both the primary and secondary displays without the need for a dedicated processor for the secondary display.

It will further be understood that “operatively cooperate”, in this context, means that at least some parts, components, indicia, or items displayed on the primary display and/or the secondary display can be interchanged or moved between the displays by an operator of the machine by means of the user interface. Some components of the operating system of a machine and one or more software programs will operatively cooperate via the primary and secondary displays.

It will also be understood that the phrase “configured to” will usually, depending on the context, refer to being programmed in the normal sense to perform a certain task.

Another way to broadly describe the invention is to have a data processing machine of which the display is visually split into a primary display and a secondary display of which at least the secondary display is a touch-sensitive user interface. Although not preferred, the usual or primary display may be a touch sensitive display as well.

The secondary display may include more than one touch-sensitive display or more than one zone on a single touch-sensitive display, which display or zone has a dedicated or preferred input function. In other words, the secondary display may be divided into separate zones, each zone having a dedicated or preferred input function. The zones may be virtually separated on a single screen or physically separated into multiple single touch-sensitive displays.

Each single touch-sensitive display or zone should preferably be in the form of a strip parallel, during use, to the primary display. In the case of more than one single touch-sensitive displays or zones, the single touch-sensitive displays or zones should preferably be parallel to each other.

A first such single touch-sensitive display or zone may be in the form of a strip to be used parallel to the primary display, in use, and located between the position usually occupied by a QWERTY keyboard and the bottom of the primary display of a data processing machine.

A second such single touch-sensitive display or touch-sensitive display zone may be in the form of a strip to be used parallel to the primary display, in use, and located in the position usually occupied by a QWERTY keyboard.

A third such single touch-sensitive display or touch-sensitive display zone may be in the form of a strip to be used parallel to the primary display, in use, and located between the position usually occupied by a QWERTY keyboard and the user of a data processing machine.

Any combination of single touch-sensitive displays or touch-sensitive display zones with each other or with any other typical user interface such as a QWERTY keyboard, touch pad or the like should preferably be integrated into one, generally planar, user interface housing.

The user interface may include a video signal connection and/or communication means with a data processing machine and a user interface connection and/or communication means with the data processing means.

An audible cue may accompany a touch or gesture on the user interface to provide user feedback or to simulate a tactile response. In another embodiment of the invention, the touch-sensitive display may be configured to be depressible in a ‘click’ fashion to provide a user with a tactile response.

The user interface may include a set of transparent keys, which, in one state, protrude upward through openings in a smooth surface to be discernable by a user as distinct keys, when a QWERTY keyboard, for example, is in use and/or displayed on the secondary display, and which keys are configured to retract to be flush with the surface, forming a smooth surface so as to present a single smooth user interface surface when the QWERTY keyboard is not in use or displayed. The user inter face may therefore include a set of keys which are configured to be raised above the surface of the secondary display. Typically a top layer of transparent material will be provided with openings for receiving keys there through and lower layer of transparent material provided with complementary raised keys with the two layers configured to be placed on a multi-touch display with the two layers being able to switch from a key protruding state to a no protruding state. The lower layer may comprise of strips, which strips can be independently switched or depressed to provide a person with a tactile response. It will be appreciated that this switching action can be achieved in many ways such as activating and deactivating an electromagnetic force with the two layers biased, or spring loaded, in an opposite state. Alternatively, strips of transparent keys may be slideable from a deposit recess at the top of the secondary display into the position of and to form a normal QWERTY type keyboard. The strips may be connected and may be slid out from the deposit recess in an “unroll” or “stack” fashion. When not in use, the strips can be slid back into the deposit recess. The strips may slide on tracks and locating means such as notches may assist in positioning the strips to form a keyboard. The track may provide contact points for the relaying electronic signal for each key.

In one embodiment of the invention, the user interface includes a first such single touch-sensitive display in the form of a multi-touch strip display to be used parallel to the primary display, in use, and located at the rear of a normal QWERTY keyboard, which touch-sensitive display will be referred to as a Multi-Touch Screen Ribbon (MSR). In this embodiment, the MSR can be located above the usual F keys or in the place of the F-keys, in which case it is configured to be toggled between a virtual F-key keypad or a secondary display input device. In the secondary display input device mode the operating system of the machine may be configured such that the MSR will display items such as a menu bar, icons, control docks or any combination thereof, which complement the primary display. A touch by a user of an item will activate or control that item. A gesture on the MSR may also activate, control or move one or more items displayed on the MSR. For example, items may operatively cooperate by being movable between the primary and secondary display. See the first example of the detailed description below. An audible cue may accompany a touch or gesture on the user interface to provide user feedback or to simulate a tactile response. In another embodiment of the invention, the touch-sensitive display may be configured to be depressible in a ‘click’ fashion to provide a user with a tactile response.

In another embodiment of the invention, the user interface includes a second such single touch-sensitive display in the form of a multi-touch strip display to be used parallel to the primary display and located in the position usually occupied by a QWERTY keyboard, which touch-sensitive display will be referred to as a Multi-Touch Screen Ribbon (MSR). Typically a virtual keyboard will be displayed over the secondary complementary display. The user interface may include sensors to detect the position of a user's hands and in particular the two index fingers of a user and the virtual keyboard may be configured to float to always be in the correct position for text input relative to the person's hands. The user interface may be configured to automatically adapt or be customisable to suit a person's typing method and/or style. The display of the virtual key board may be removable by a user typically by a gesture at which point the MSR may take a similar function as described above for the first such single touch-sensitive display or may take a similar function as described above or the third such single touch-sensitive display as described below. An audible cue may accompany a touch or gesture on the user interface to provide user feedback or to simulate a tactile response. In another embodiment of the invention, the touch-sensitive display may be configured to be depressible in a ‘click’ fashion to provide a user with a tactile response. In another preferred embodiment, when the virtual keyboard is being displayed, a set of transparent keys are raised above the surface of the touch-sensitive display to provide QWERTY keyboard.

In yet another embodiment of the invention, the user interface includes a third such single touch-sensitive display in the form of a multi-touch strip display to be used parallel to the primary display, in use, and located between the position usually occupied by a QWERTY keyboard and the user of a data processing machine. The touch-sensitive display will be referred to as a Multi-Touch Screen Ribbon (MSR). This is typically the position normally occupied by a touchpad of a laptop type PC. Typically a virtual touchpad will be displayed over the secondary complementary display. The virtual touchpad may be configured to float to always be in the correct position for text input relative to the person's hands. The user interface may include sensors to detect the position of a user's hands to deactivate the MSR while a person is typing on a keyboard or to float the virtual touchpad into the correct position. The display of the virtual touchpad may be removable by a user typically by a gesture at which point the MSR may take a similar function as described above for the first such single touch-sensitive display or may take a similar function as described above or the second such single touch-sensitive display as described above. An audible cue may accompany a touch or gesture on the user interface to provide user feedback or to simulate a tactile response. In another embodiment of the invention, the touch-sensitive display may be configured to be depressible in a ‘click’ fashion to provide a user with a tactile response.

Any combination the above described MSR's of the above described embodiments may be combined and the display of the primary display and the MSR's will then complement and/or and operatively cooperate with each other such as together forming a coherent or single display.

In yet a further embodiment of the invention, the user interface includes a single touch-sensitive display in the form of a multi-touch display to be used parallel to the primary display, in use, and located at the position usually occupied by a keyboard or console of a laptop type PC. The user interface includes any combination of the above described first, second or third such touch-sensitive display zones. Each zone is similar in form and function as described above for the corresponding single first, second or third such touch-sensitive displays. It will be appreciated that the secondary display can be large relative the MSR embodiments described above and when used in complement with the primary display in transverse relation it can be useful to give a three dimensional view to enhance a user's visual experience and for certain applications such as computer games, computer aided design software and the like. Another advantage is the availability of multiple displays.

In yet a further embodiment of the invention, the user interface includes a single touch-sensitive display in the form of a multi-touch display to be used together with the primary display, in use, and which is configured to display a virtual hardware input device such as a control surface, a media mixing console window a multimedia editing control device such as a Mackie® control surface, a sound mixing panel, a video game controller, a joystick, flight simulator controls and the like input devices for a data processing machine. It will be appreciated that a number of such controls can be simulated avoiding the need for such hardware peripheral devices.

In yet a further embodiment of the invention, the user interface includes a touch-sensitive display in the form of a multi-touch display to be used together with the primary display, in use, and which is configured to display a special character screen by activating a special character icon.

In yet a further embodiment of the invention, the user interface includes a touch-sensitive display in the form of a multi-touch display to be used together with the primary display, in use, and which is configured to display a live view mode by activating a live view icon. In the live view mode, part or the whole of the primary display drops down to the secondary display to allow a user to directly interact with it. A primary display slider allows this view to be scrolled on the secondary display, which may be smaller than the primary display.

In yet a further embodiment of the invention, the user interface includes a touch-sensitive display in the form of a multi-touch display to be used together with the primary display, in use, and which is configured to display any one of a series of keyboard sets by activating a keyboard control dock which display an icon for each keyboard in the set. For example, a normal QWERTY keyboard, a keyboard provided with a virtual predefined function keys, language sets and a dedicated keyboard for a specific software application wherein the short cut keys for that application are graphically displayed or indicated by displayed text. This last keyboard can typically be toggled by an icon representing a current application keyboard.

In yet another aspect of the invention there is provided a finger pointing and interaction tool by activating or scrolling a cursor switch icon. This tool is a software assisted touch tool to enable precise pointing despite the clumsy nature of touch control. Typically the tool includes graphic indicia which include a target point. The target point may be slightly removed from the actual contact point of a person's finger to be visible. For right hand users the target point should be on the left had side while on the right hand side for left hand users. The graphic indicia may further include shortcut keys such as a zoom function and/or tool select key. The indicia may further include an active display zone for displaying which type of tool or function is in use. Typically this tool will float under a person's finger and can be used for precise pointing application without the need of a track ball, mouse, stylus or the like pointing device.

The inventor is also aware that the “click” tactile response, especially from a QWERTY keyboard, is important feedback to a user. The second single touch-sensitive display or touch-sensitive display zone may be in the form of a plurality, preferably six, strips parallel to each other and which are depressible relative to each other. The strips may preferably be configured to provide a mechanical “click” or an audible click. The strips may be transparent strips overlaying a multiple touch-sensitive display or strips of multiple touch sensitive displays. It will be appreciated that limiting the strips to a number of six, covers all the keys of a normal QWERTY keyboard while having the advantage of avoiding to construct a complex user interface wherein all the keys are configured to give a mechanical click tactile response. In another preferred embodiment, when the virtual keyboard is being displayed, a set of transparent keys is raised above the surface of the touch-sensitive display to provide a normal QWERTY keyboard.

The user interface may include one or more processors configured to process user inputs, sensor inputs, display of virtual input devices and/or audible sounds related to tactile response.

It will be appreciated that the customising options, configuration, adaptation, use, software, operating systems and other aspects of the invention and combinations thereof is too numerous too describe and the failure to describe all possibilities should not be interpreted as limiting the invention.

It will also be appreciated that most existing software applications can be adapted to be implemented on the user interface in accordance with the invention.

According to a further aspect of the invention, there is provided an operating system for operating a user interface as described above, which operating system is adapted or configured by means of software to provide the functionality of the user interface as described above.

### DETAILED DESCRIPTION OF THE INVENTION

The invention is now described by way of example with reference to the accompanying drawings.

The intellectual property of the icons used for illustrative purposes only are owned by Apple Corporation and in no way implies that the inventor has any rights thereto.

In the drawings:

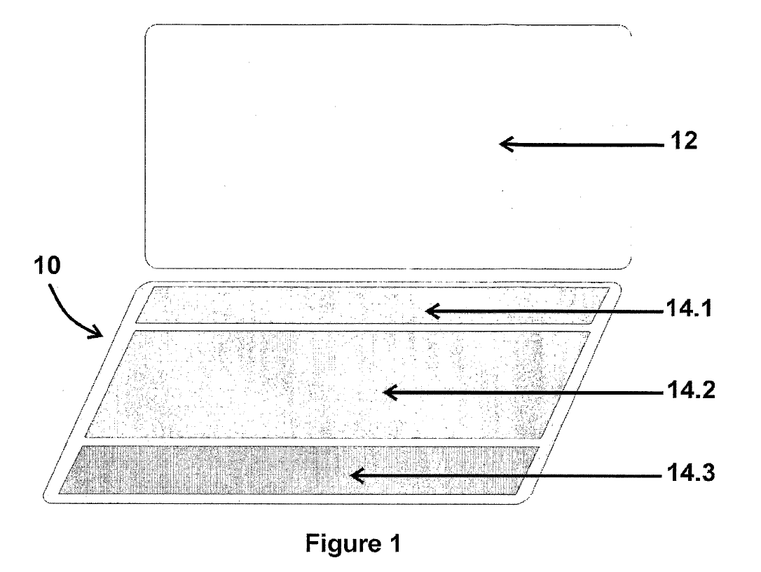

FIG. 1 shows schematically a user interface, in accordance with the invention;

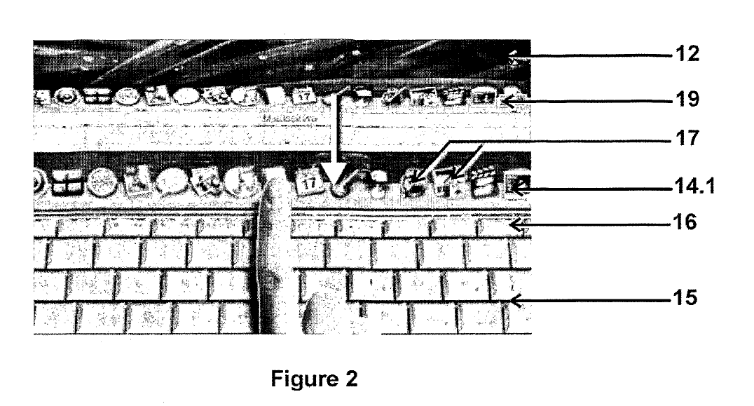

FIG. 2 shows part of a primary and secondary display;

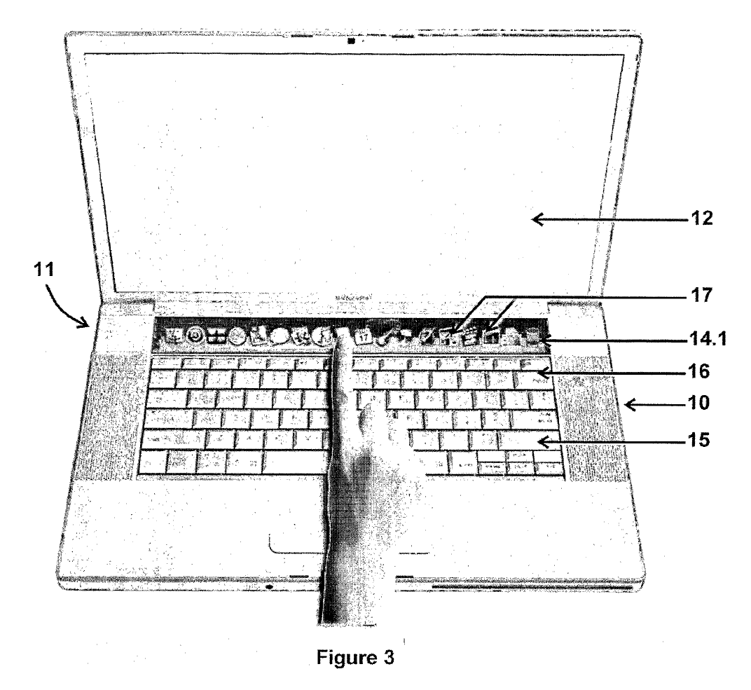

FIG. 3 shows a notebook PC incorporating a first embodiment of the invention in accordance with the invention;

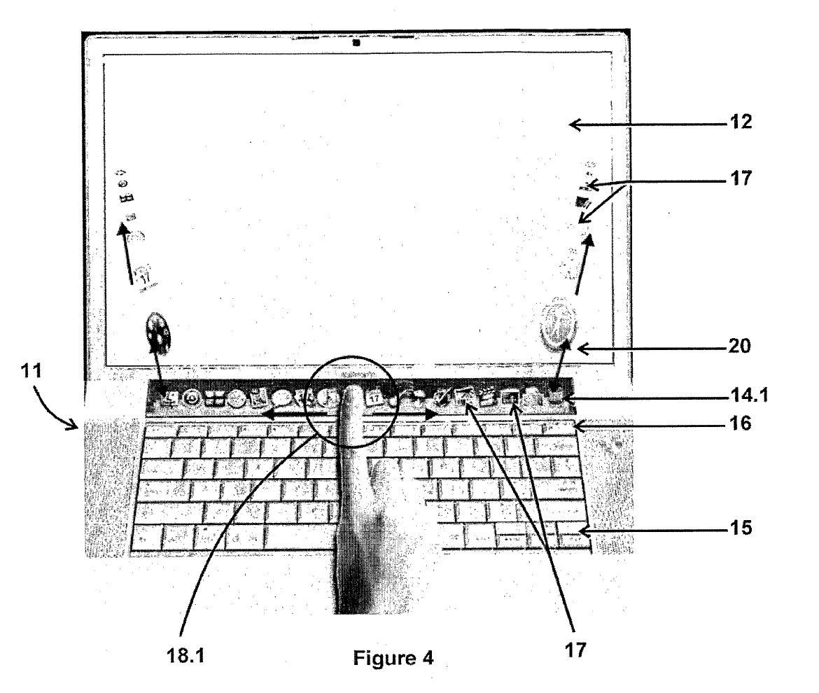

FIG. 4 shows the notebook PC incorporating the first embodiment;

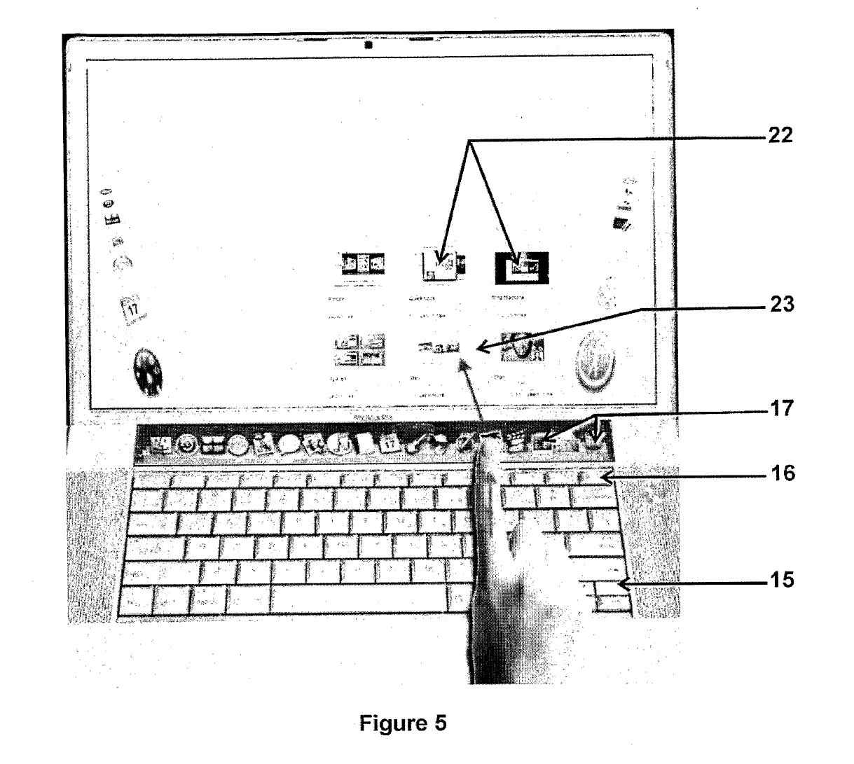

FIG. 5 shows operative cooperation between a primary and secondary display;

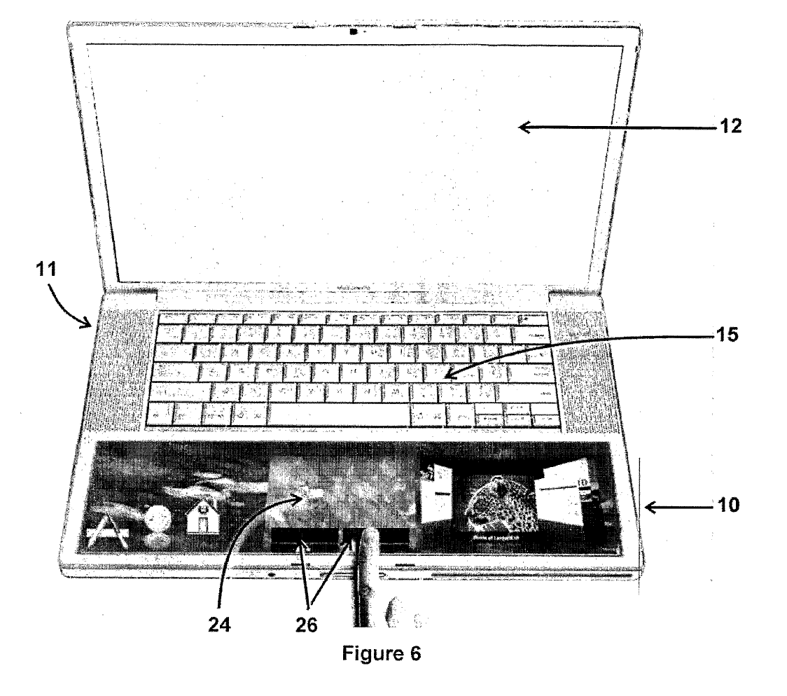

FIG. 6 shows a notebook PC incorporating another embodiment of the invention in accordance with the invention;

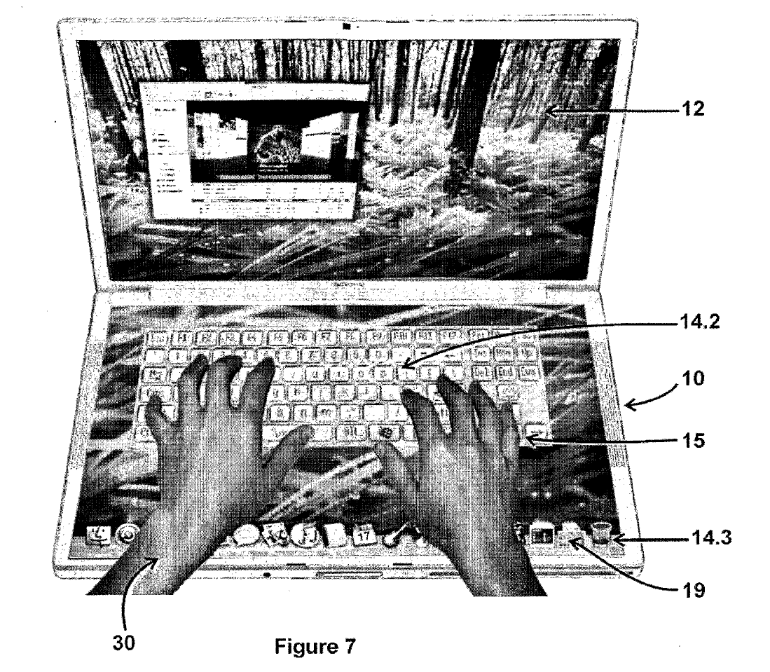

FIG. 7 shows a notebook PC incorporating a further embodiment of the invention, in accordance with the invention;

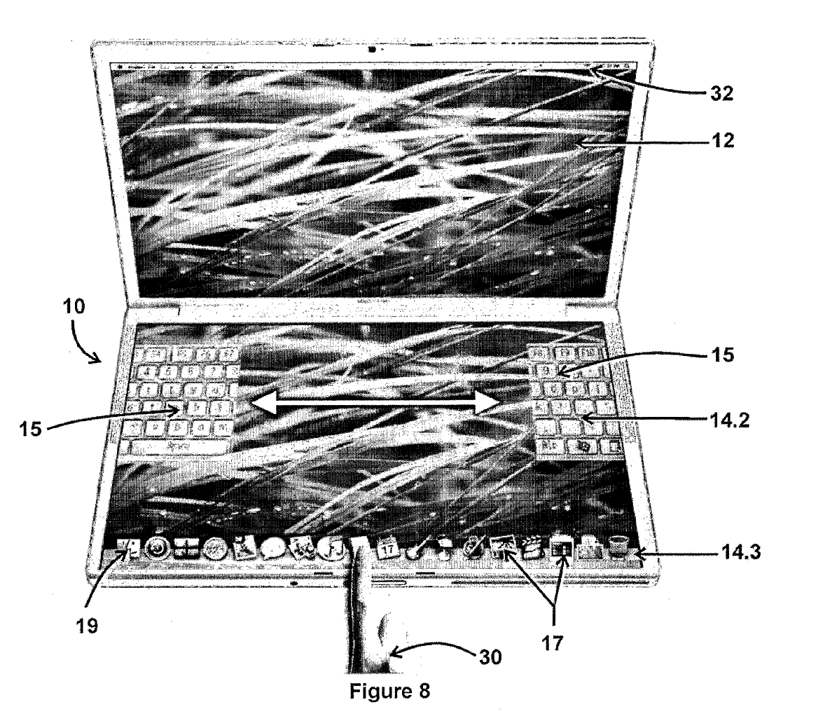

FIG. 8 shows the notebook PC incorporating the further embodiment of the invention;

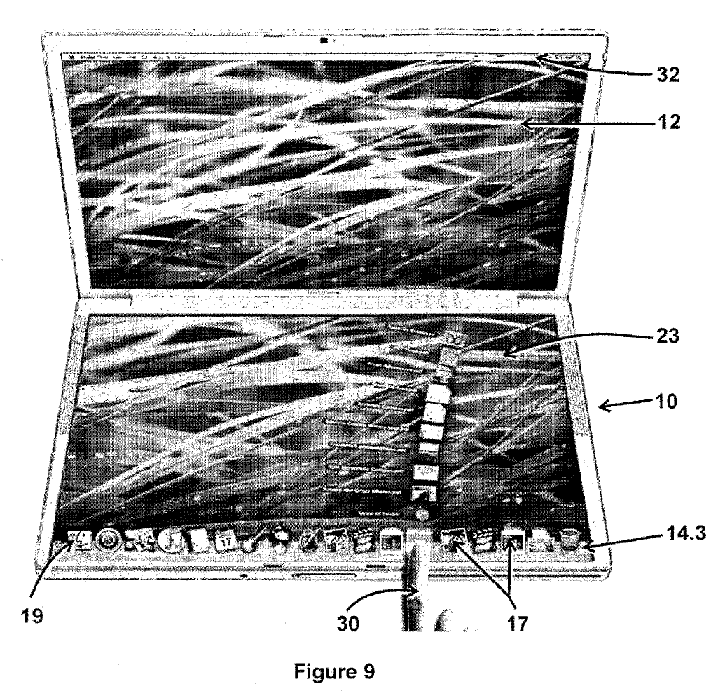

FIG. 9 shows the notebook PC incorporating the further embodiment of the invention;

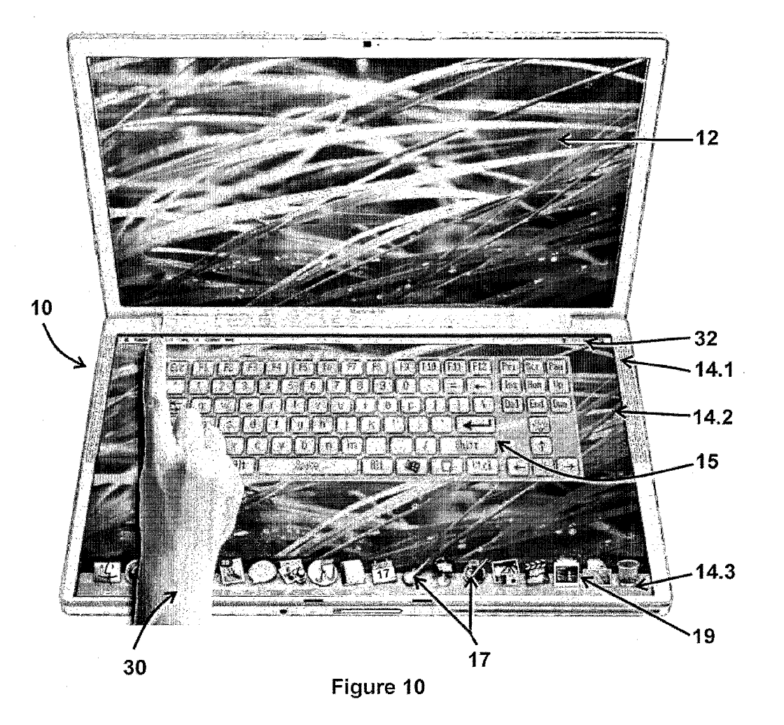

FIG. 10 shows the notebook PC incorporating the further embodiment of the invention;

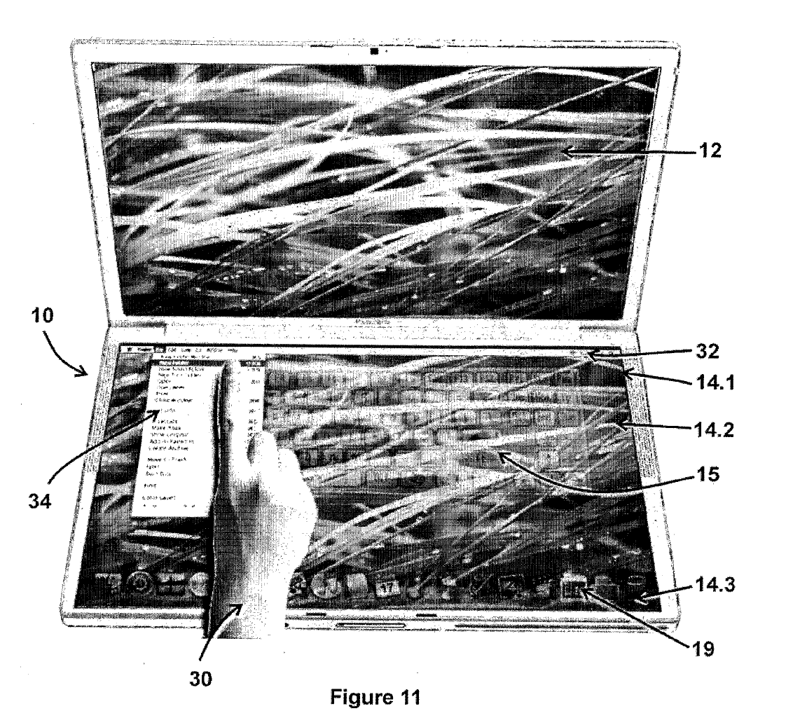

FIG. 11 shows the notebook PC incorporating the further embodiment of the invention;

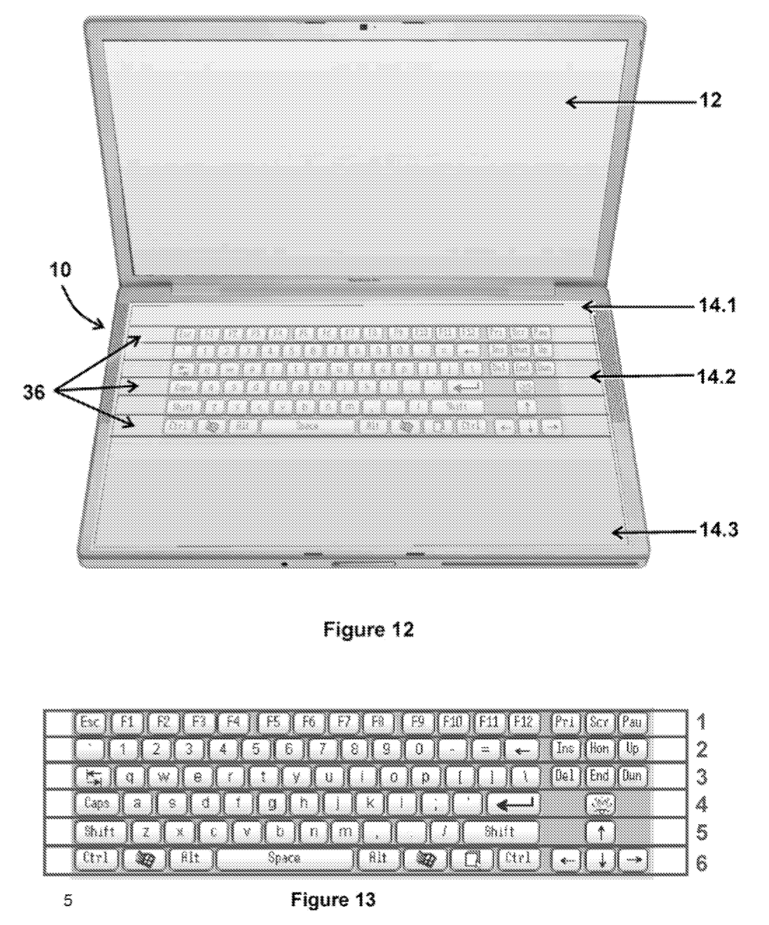

FIGS. 12 and 13 show a notebook PC incorporating an even further embodiment of the invention, in accordance with the invention;

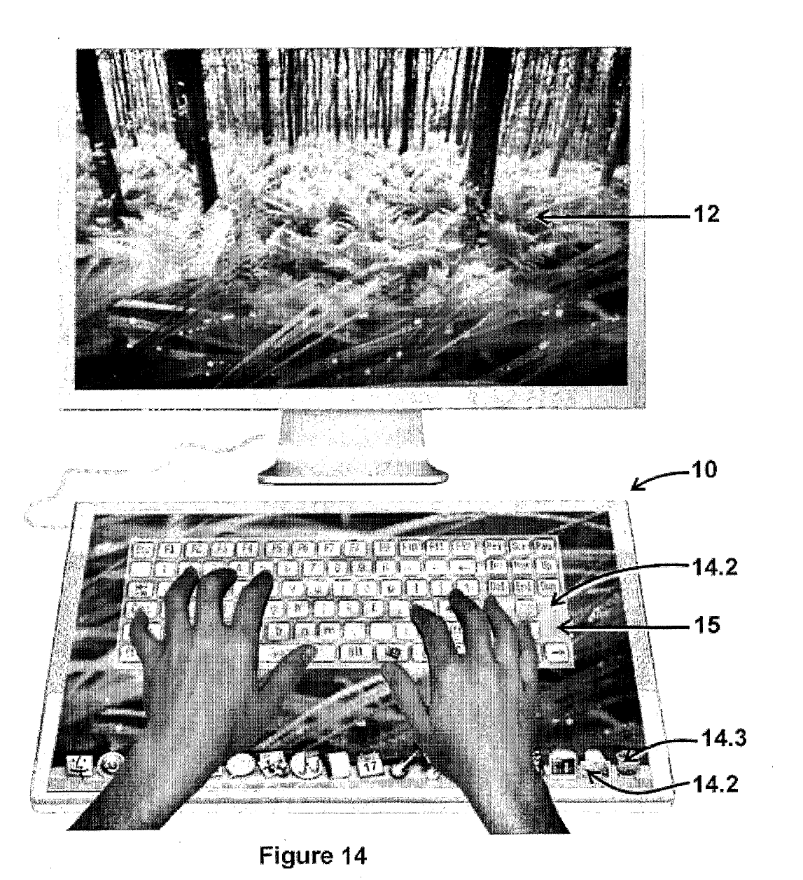

FIG. 14 shows use of another embodiment of the invention with a desktop type PC, in accordance with the invention;

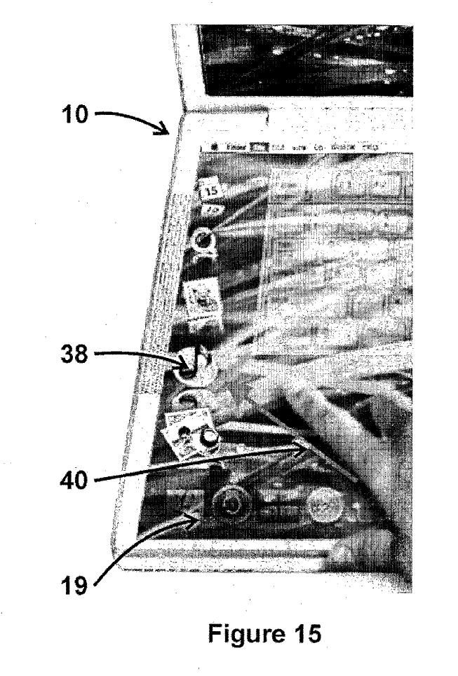

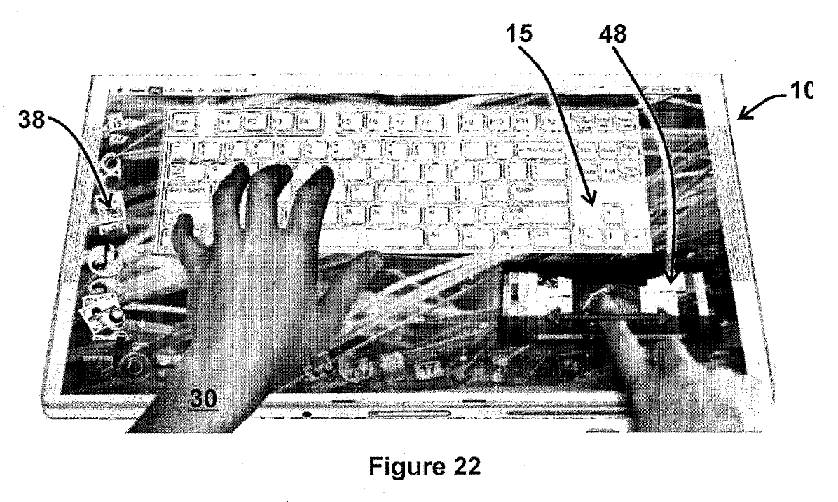

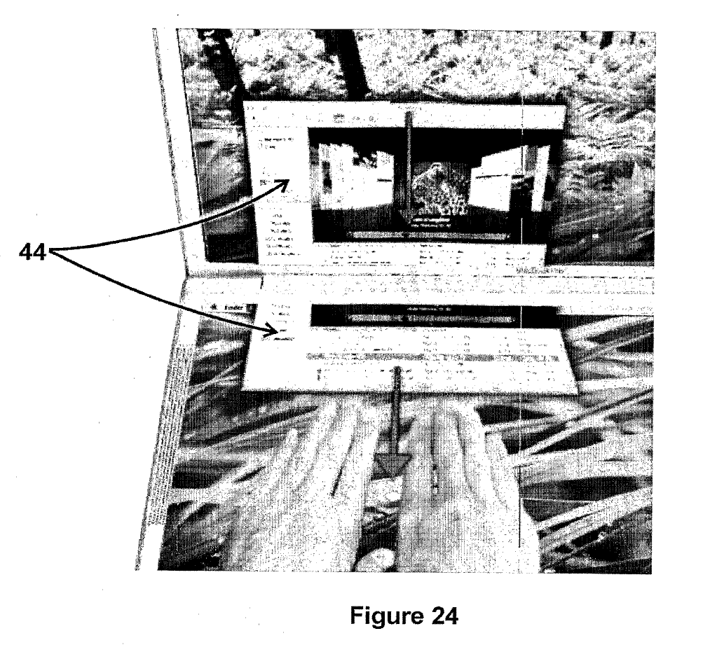

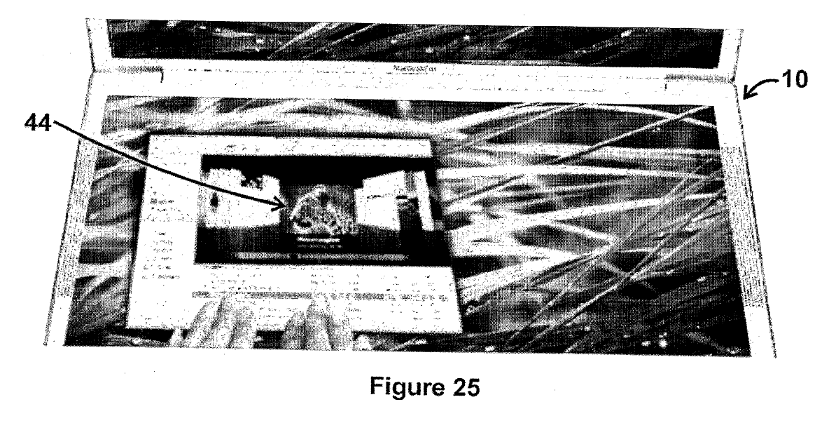

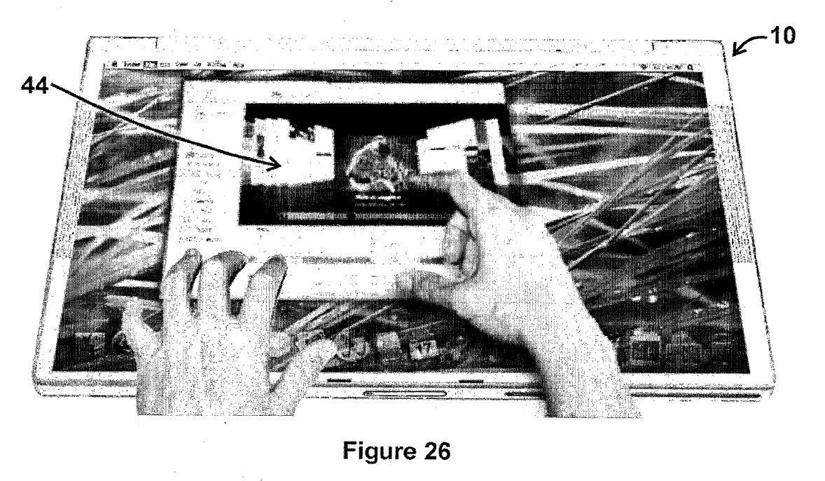

FIGS. 15 to 35 demonstrate further ways in which the user interface, in accordance with the invention can be used;

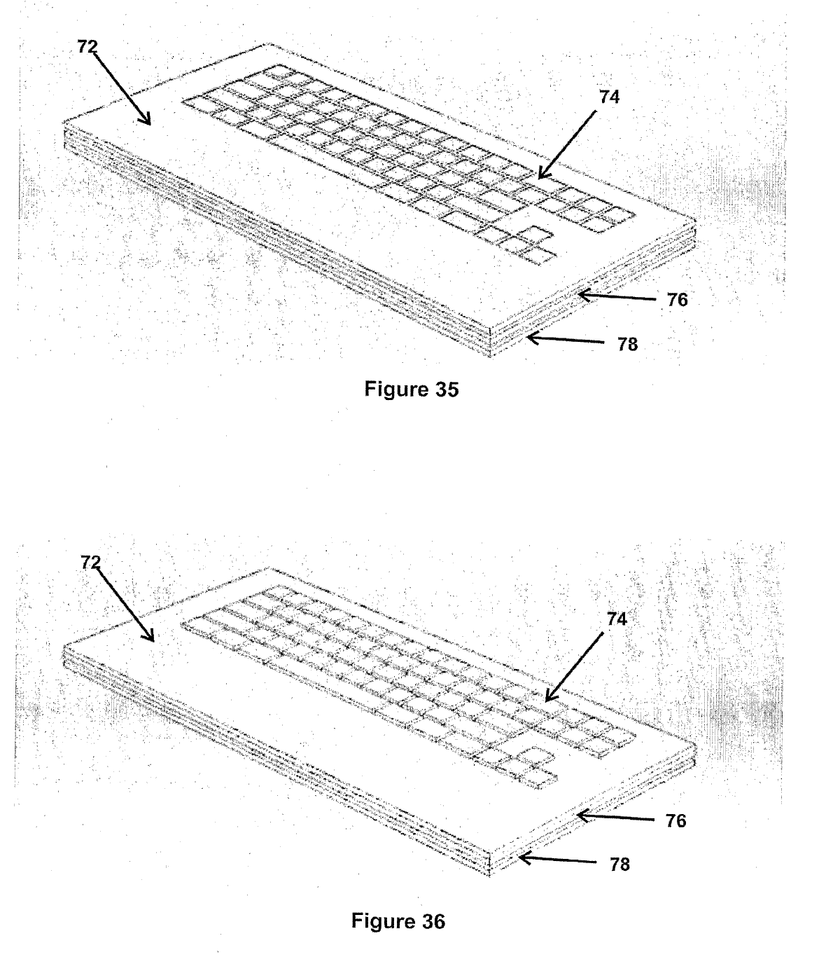

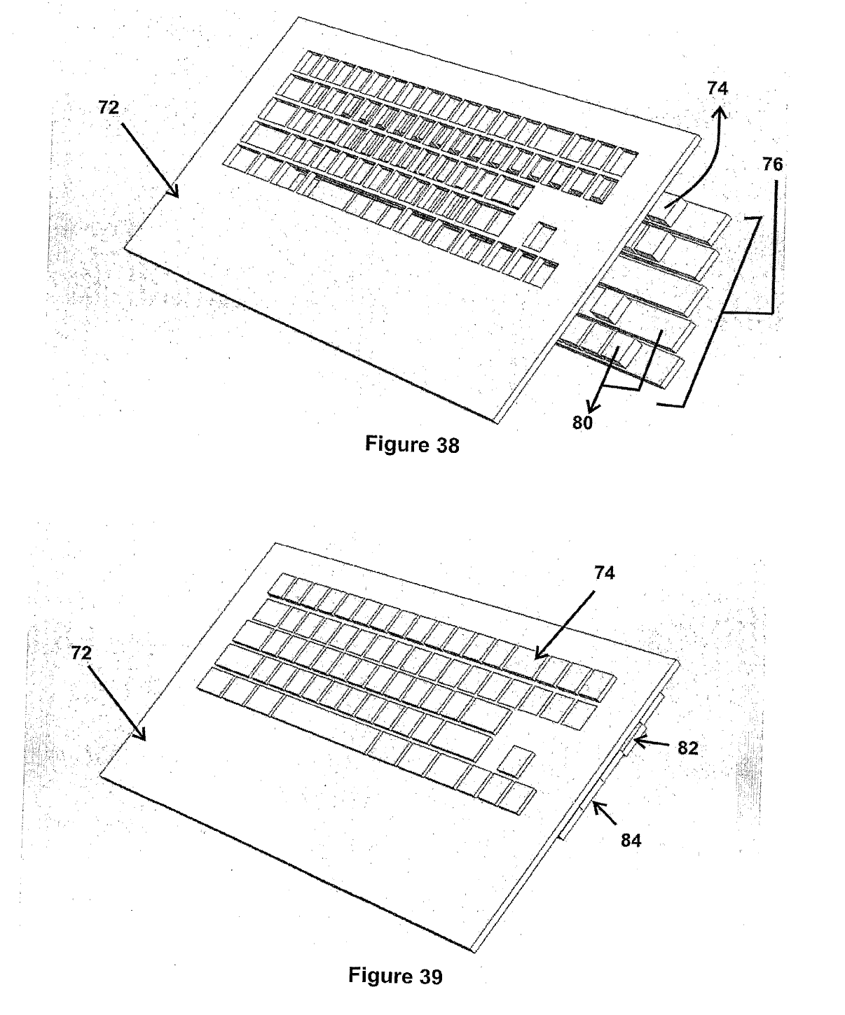

FIGS. 35 to 39 shows examples of a keyboard, in accordance with the invention;

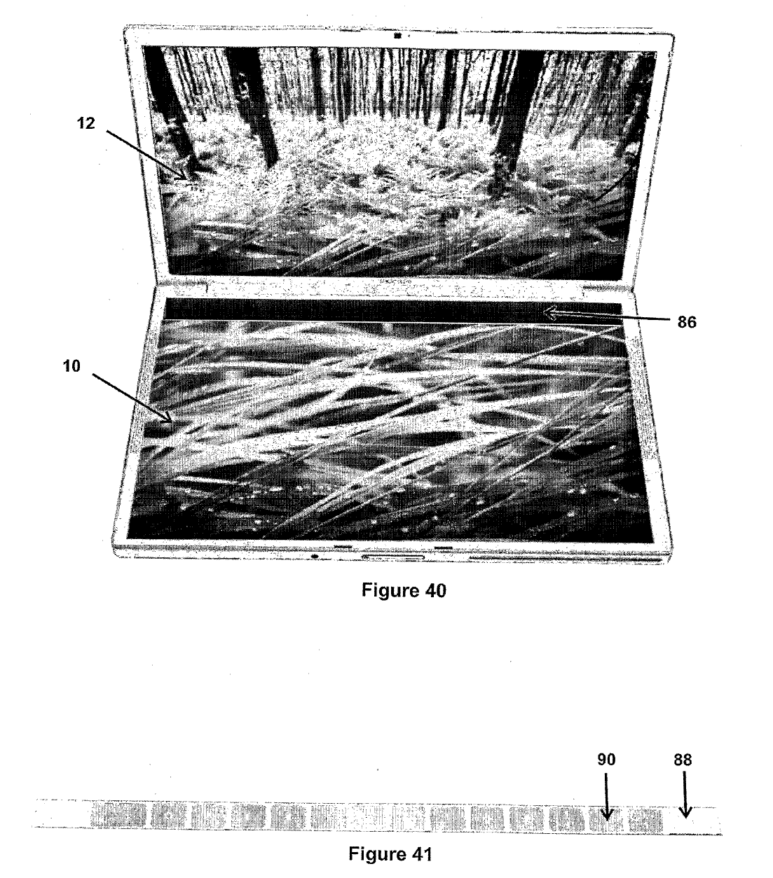

FIGS. 40 to 45 shows a further example of a keyboard, in accordance with the invention; and

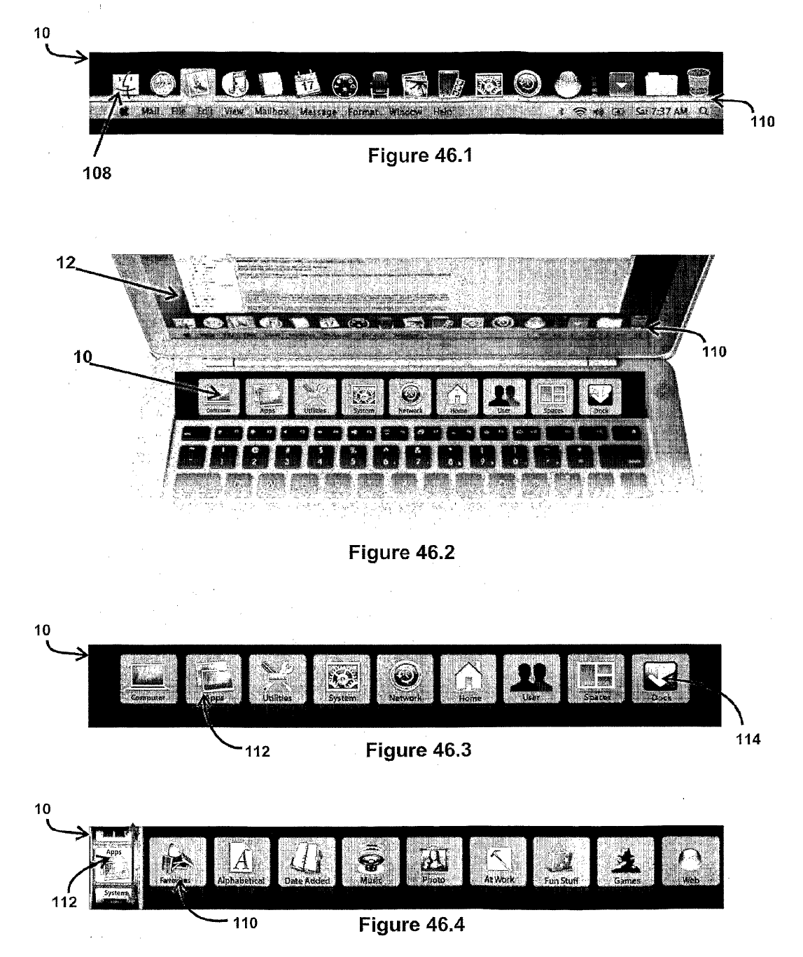

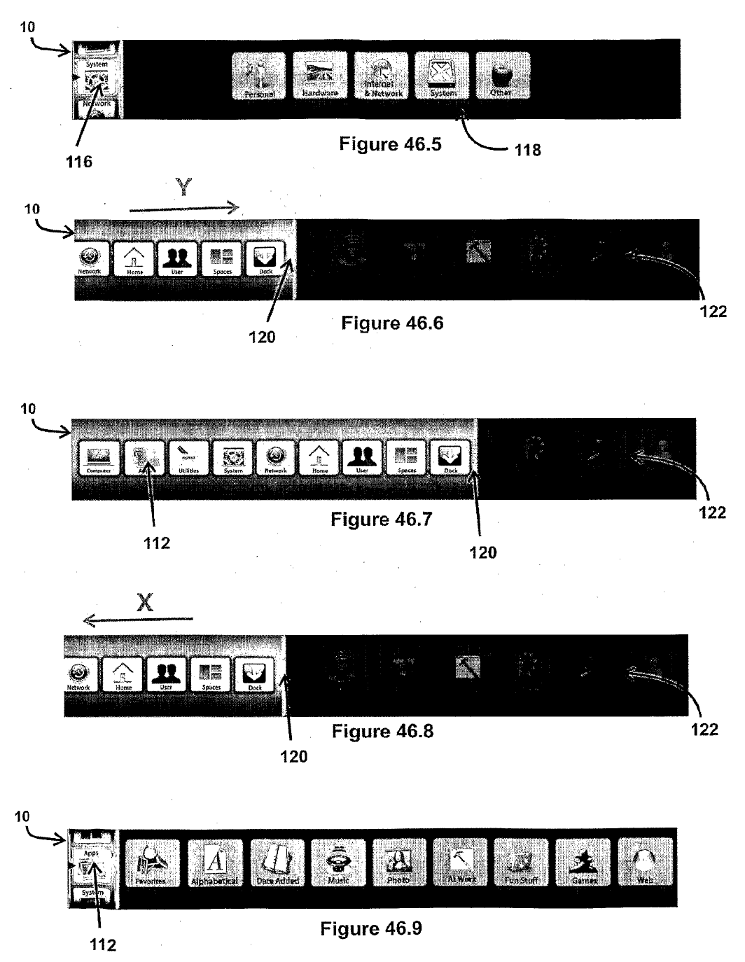

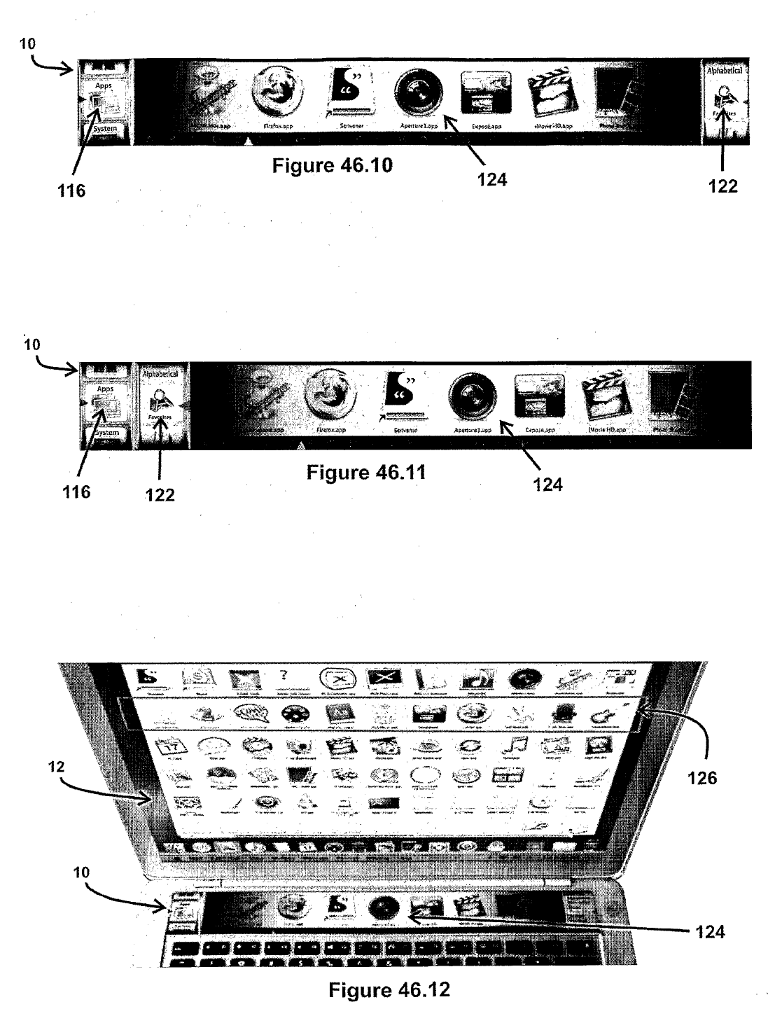

FIGS. 46.1 to 54 shows several examples of how the graphic display of the input device is configured to complement and operatively cooperate with the graphic display of the usual display screen

Referring now to the drawings, the user interface, in accordance with the invention, is generally indicated by reference numeral 10.

The user interface 10 for a data processing machine 11 in the form of a laptop PC is combined with a usual primary display 12 screen for the machine or is configured to be used with a machine which usually includes a primary usual display screen 12. The user interface 10 includes a multi-touch-sensitive display screen, a secondary display screen 14, which is configured to be an input device for the machine and configured such that the graphic display of the input device is configured to complement and operatively cooperate with the graphic display of the usual display screen 12.

The secondary display 14 includes more than one touch-sensitive display, in one embodiment of the invention, or more than one zone on a single touch-sensitive display, in another embodiment of the invention, with each display or zone having a dedicated or preferred input function. The secondary display is divided into three separate zones 14.1, 14.2, and 14.3, each zone having a dedicated or preferred input function. The zones 14 are virtually separated on a single screen, in one embodiment of the invention. In another embodiment of the invention, the zones are physically separated into multiple single touch-sensitive displays.

A first such single touch-sensitive display or zone 14.1 is in the form of a strip parallel to the primary display, in use, and located between the position usually occupied by a QWERTY keyboard and the bottom of the primary display of a data processing machine.

A second such single touch-sensitive display or zone 14.2 is in the form of a strip parallel to the primary display, in use, and located in the position usually occupied by a QWERTY keyboard.

A third such single touch-sensitive display or zone 14.3 is in the form of a strip parallel to the primary display, in use, and located between the position usually occupied by a QWERTY keyboard and the user of a data processing machine.

In a first example, in one embodiment of the invention (FIGS. 2 to 5), the user interface 10 includes a first such single touch-sensitive display 14.1 in the form of a multi-touch strip display parallel to the primary display 12 and located at the rear of a normal laptop PC QWERTY keyboard 15, which touch-sensitive display will be referred to as a Multi-Touch Screen Ribbon (MSR). In this example, the MSR 14.1 is located above the usual F keys 16. The operating system of the machine, the Apple™ is configured such that the MSR 14.1 will display the control dock 19 normally displayed at the bottom of the primary display, complementing the primary display 12. The operating system is further configured such that items 17 operatively cooperate by being movable between the primary 14.1 and secondary display 12 by means of a gesture 18.1 (FIG. 4). The control dock can be scrolled or rolled passed its edges between the MSR 14.1 and upward 20 onto the Primary Display 12. The operating system is further configured such that items operatively cooperate by being expandable to an expanded item in 22, in the form of a stack menu, between the primary 14.1 and secondary display 12 by means of an upward gesture (FIG. 5). A further up or down movement or gesture then moves between selectable items on the expanded item 22 or stack menu and a single touch by a user on a highlighted selectable item of the expanded item or menu will further select that item and so on. The processor of the data input machine is configured to provide an audible cue accompany a touch or gesture on the MSR 14.1 to provide user feedback or to simulate a tactile response.

In a second example, in another embodiment of the invention (FIG. 1), the user interface 10 includes a second such single touch-sensitive display 14.2 in the form of a multi-touch strip display parallel to the primary display 12 and located in the position usually occupied by a QWERTY keyboard 15, which touch-sensitive display will be referred to as a Multi-Touch Screen Ribbon (MSR). A virtual keyboard is displayed over the secondary complementary display. The user interface includes sensors in the form of image sensors to detect the position of a user's hands and in particular the two index fingers of a user and the virtual keyboard may be configured to float to always be in the correct position for text input relative to the person's hands. The user interface may be configured to automatically adapt or be customisable to suit a person's typing method and/or style. The display of the virtual key board may be removable by a user typically by a gesture at which point the MSR may take a similar function as described above for the first such single touch-sensitive display 14.1 or may take a similar function as described above for the third such single touch-sensitive display 14.3 as described below. The processor of the data input machine is configured to provide an audible cue accompany a touch or gesture on the MSR 14.2 to provide user feedback or to simulate a tactile response.

In a third example, in another embodiment of the invention (FIG. 6), the user interface 10 includes a third such single touch-sensitive display 14.3 in the form of a multi-touch strip display parallel to the primary display 12 and located and located between the position usually occupied by a QWERTY keyboard 15 and the user of a data processing machine. The touch-sensitive display 14.3 will be referred to as a Multi-Touch Screen Ribbon (MSR). This is typically the position normally occupied by a touchpad of a laptop or notebook type PC. Typically a virtual touchpad 24 will be displayed over the secondary complementary display. The processor of the data input machine is configured such that the virtual touchpad floats to some extent to be in the correct position for cursor movement and mouse click inputs 26 relative to the person's hands. The user interface may include sensors (not shown) to detect the position of a user's hands to deactivate the MSR 14.3 while a person is typing on a keyboard 15 or to float the virtual touchpad 24 into the correct position. The display of the virtual touchpad is removable by a user typically by a gesture at which point the MSR will take a similar function as described above for the first such single touch-sensitive display 14.1 or may take a similar function as described above or the second such single touch-sensitive display 14.2 as described above. The processor of the data input machine is configured to provide an audible cue accompany a touch or gesture on the MSR 14.3 to provide user feedback or to simulate a tactile response.

In a fourth example (FIGS. 7 to 11 and 14), the user interface 10 includes a single touch-sensitive display 14 in the form of a multi-touch display to be used parallel to the primary display 12, in use, and located at the position usually occupied by a keyboard or console of a laptop type PC or as shown in FIG. 14, with a desktop type PC. The touch-sensitive-display will be referred to as a Multi-Touch Screen Ribbon (MSR). The user interface 10 includes a combination of the first, second or third such touch-sensitive display zones, 14.1, 14.2 and 14.3, respectively. Each zone is similar in form and function as described above for the corresponding single first, second or third such touch-sensitive displays. The user interface 10 in this example includes image sensors (not shown) for sensing whether a user's hands 30 are positioned to respectively make an input in one of zones 14.1, 14.2 or 14.3. When the hands 30 of a user is positioned to make an input in one zone, a processor is configured to deactivate the other zones to prevent accidental or non intended input by a user. When no hands are sensed, all zones are active. The deactivated zone is greyed out and more transparent by the processor to show a user its status and to alloy the graphics displayed on the secondary display to be more visible. In this example, the Apple® type operating system is configured to display the control dock 19 in zone 14.3. A virtual keyboard 15 is displayed in zone 14.2 and a popup menu bar 32 in zone 14.1, which moves down from the top of the primary display (FIGS. 10 and 11). The operating system is further configured to allow removal of the virtual keyboard by activating the control dock to expansion of each icon 17 displayed on the dock 15 (FIG. 9). When a user's hand 30 is sensed near the zone 14.1, the virtual keyboard is greyed out and the menu bar 32 drops down from the primary display 12 to the MSR, or secondary display, in an operatively cooperative manner. Touching any of the selectable items on the menu bar 32, a drop down menu 34 overlays the greyed out virtual keyboard 15, from which more items can be selected. Although the above user interface 10 minimises the use of a curser, a virtual touch pad can be activated by touching the corresponding item 17 on the control dock (not shown). An audible “click” sound may accompany a touch and other sounds may accompany gestures to simulate a tactile response.

In a further embodiment of the invention (FIGS. 12 and 13), which can be combined with example 4 above, the second single touch-sensitive display zone 14 is divided into six strips 36 parallel to each other and which are depressible relative to each other and configured to provide a mechanical “click” to provide a tactile response to the user. The strips may be transparent strips overlaying a multiple touch-sensitive display, which strips are depressible.

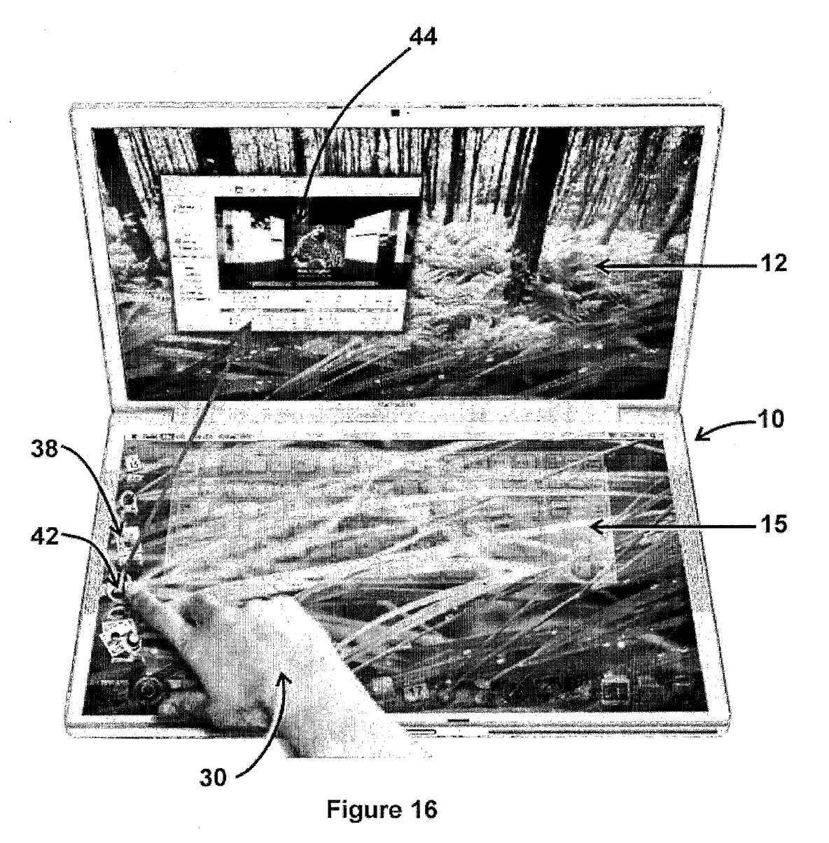

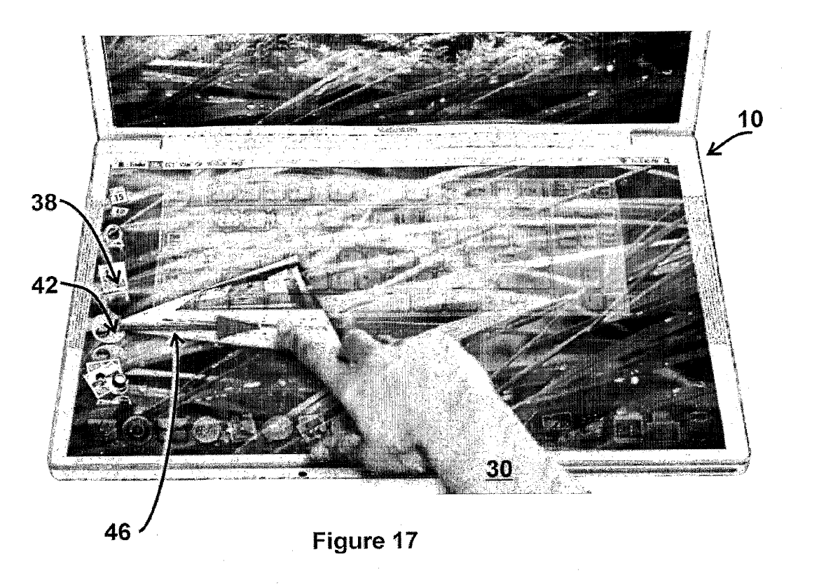

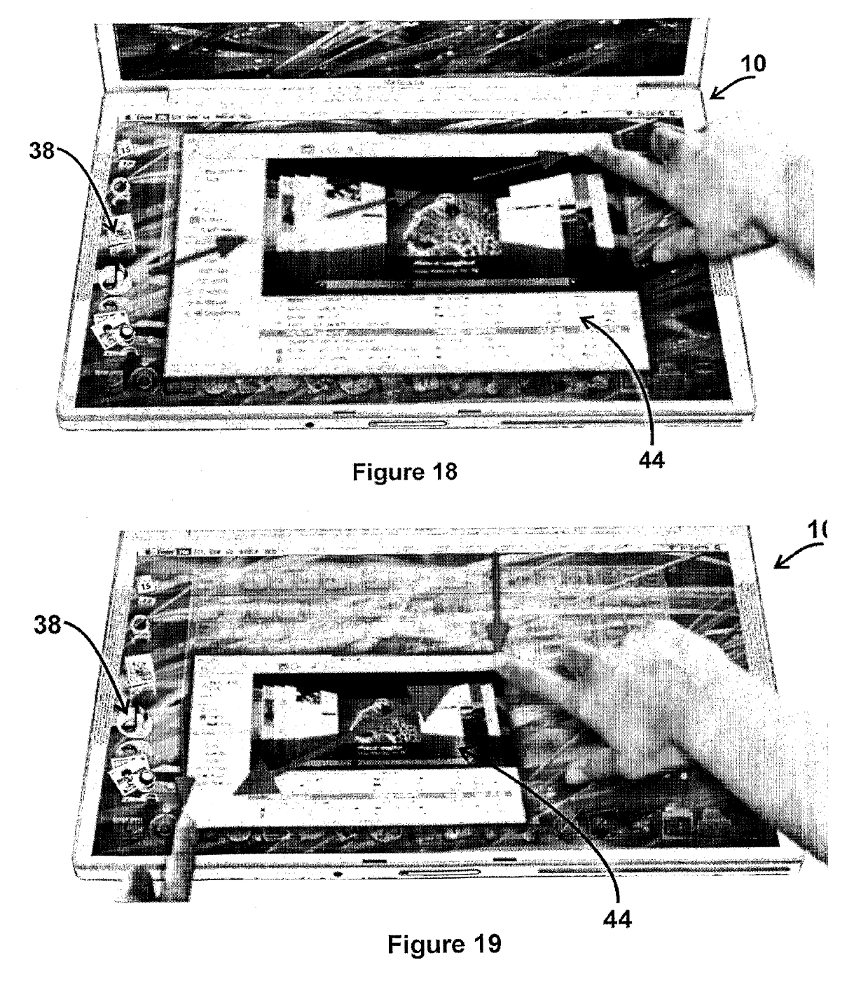

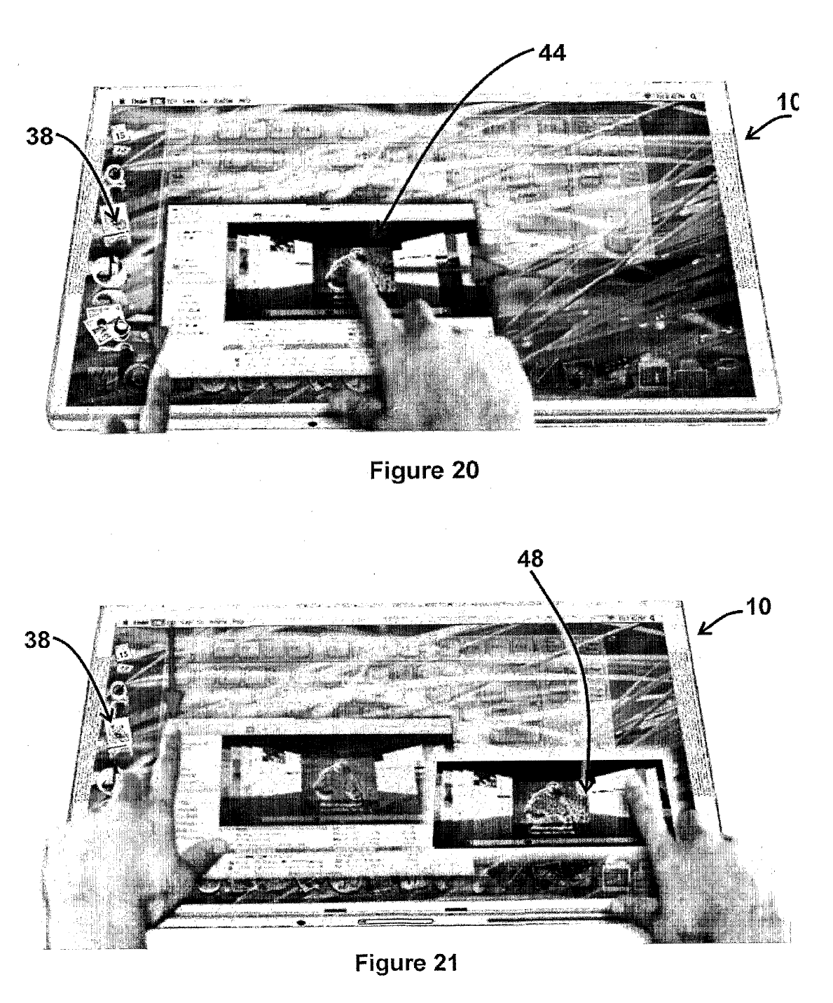

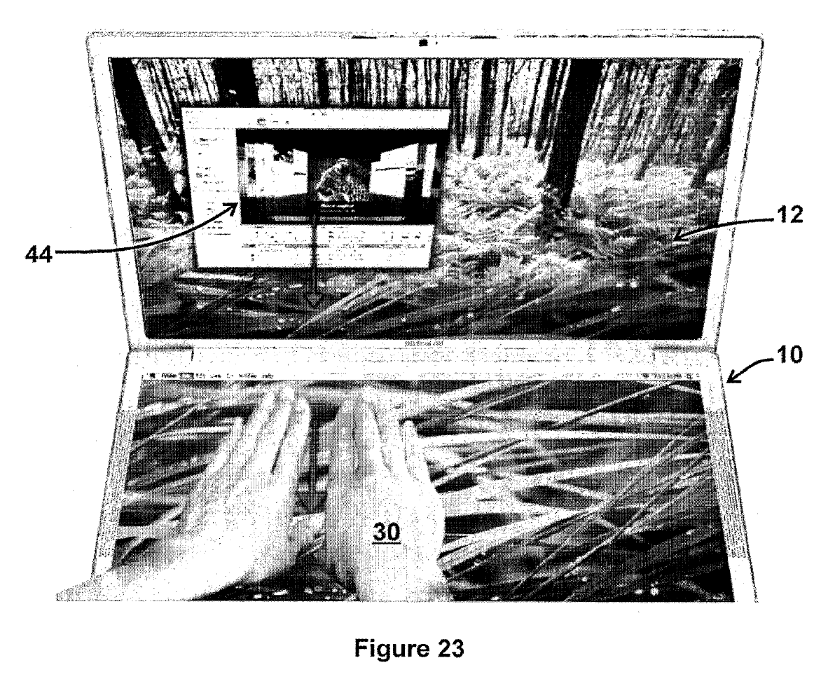

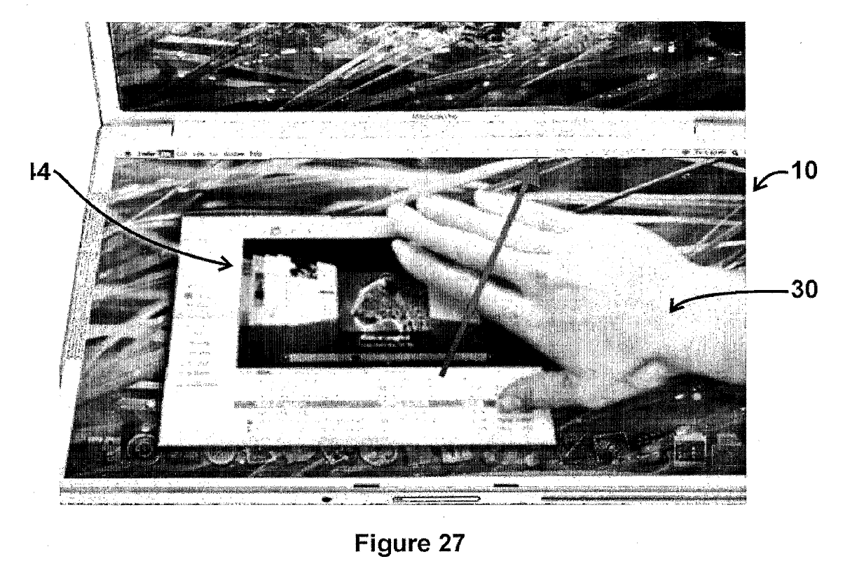

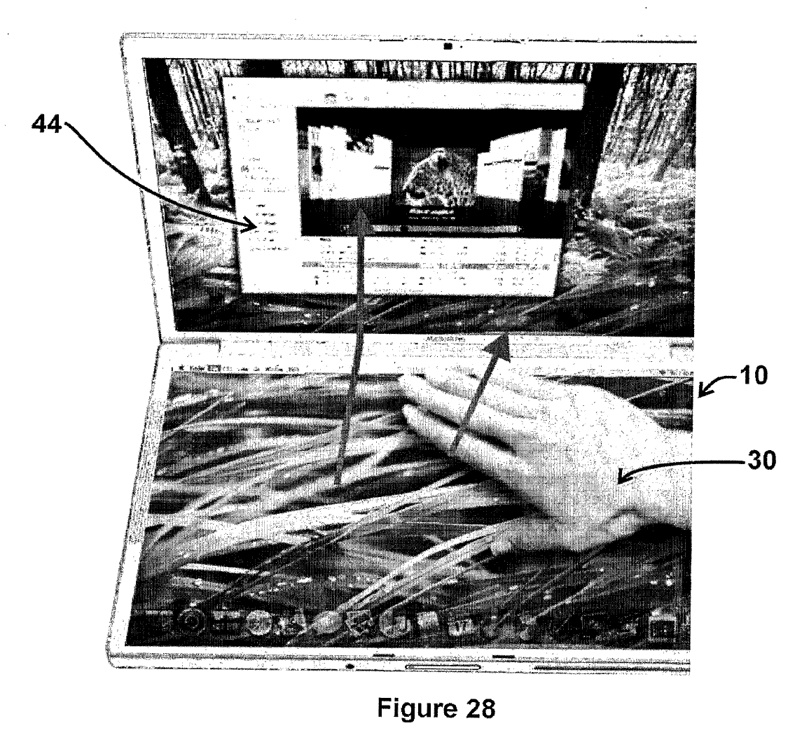

As described in the fourth example above, further demonstrations of ways in which this user interface can be used are shown in FIGS. 15 to 28. An active program menu bar 38 is displayed on the left side of the user interface 10. A program can be activated by a gesture 40 from the control bar 19 to active program menu bar 38 (FIGS. 15 and 16). Once the program is active a user 30 can scroll between different activated programs by a single touch of the relevant icon 42, Itunes® in this example, to display the window 44 on the primary display 12 and the program can be manipulated in the usual way. The operating system is configured to activate to a gesture of double tapping on the icon 42 to open an options menu. Additionally (FIG. 17), the gesture 46, dragging the icon 42 to the right will open the program on the secondary display, where it can be manipulated using the multi-touch display, FIG. 18. FIG. 19 shows how a gesture how to resize the active window 44. FIGS. 20 to 22 shows how the different elements of the active program can be manipulated, separated and used in conjunction with the virtual keyboard 15. In this example, the user 30 holds down the bottom left corner of the active program window 44 and swipes an area 48 of the program window to the right, to become a new control area for the active program. The remainder of the window 44 moves to the primary display or may be closed if the user 30 does not intend to use the remaining controls. This example also shows how a user would manipulate more than one active program at the same time. The virtual keyboard 15 can be used to control another active program displayed on the primary display while the user selects multimedia on the new control 48. As shown in FIGS. 23 to 26, a user 30 can drag an active program window from the primary display 12 to access full multi-touch display control over the program and as shown in FIGS. 27 and 28, the user 30 can “throw” back the window 44 to the primary display in order to clean up the user display for other uses or, when done with the full multi-touch display.

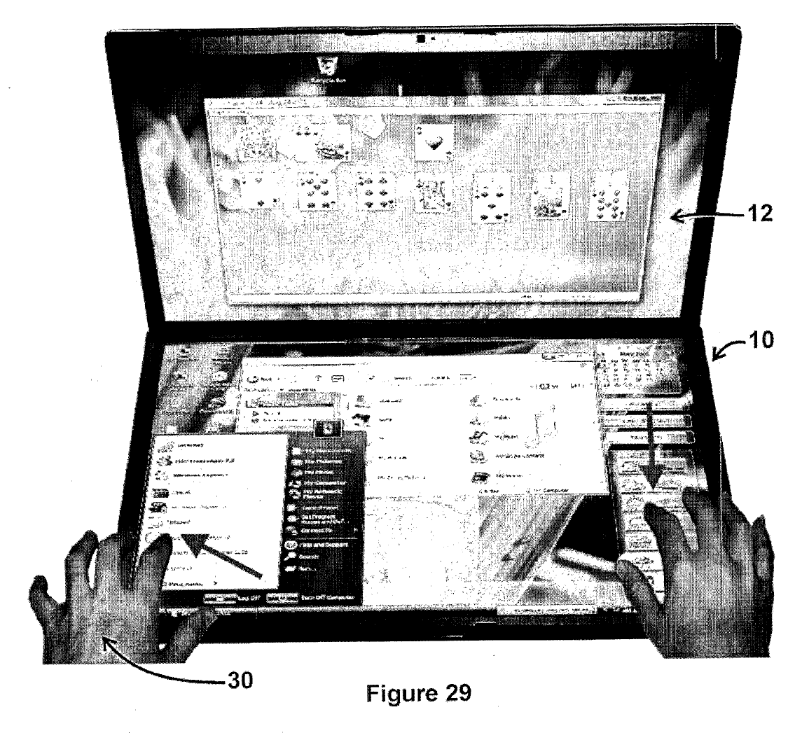

FIG. 29 demonstrates how the user interface 10 in accordance can me used complementary and operatively cooperatively with a primary display 12 using an operating system such as Windows® Vista® to control and view multiple programs and functions.

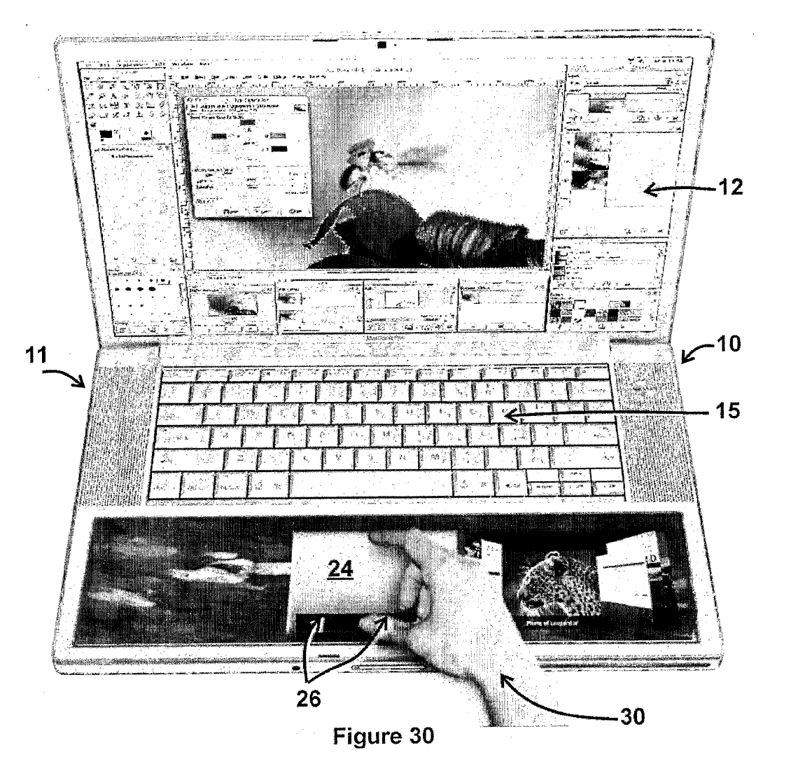

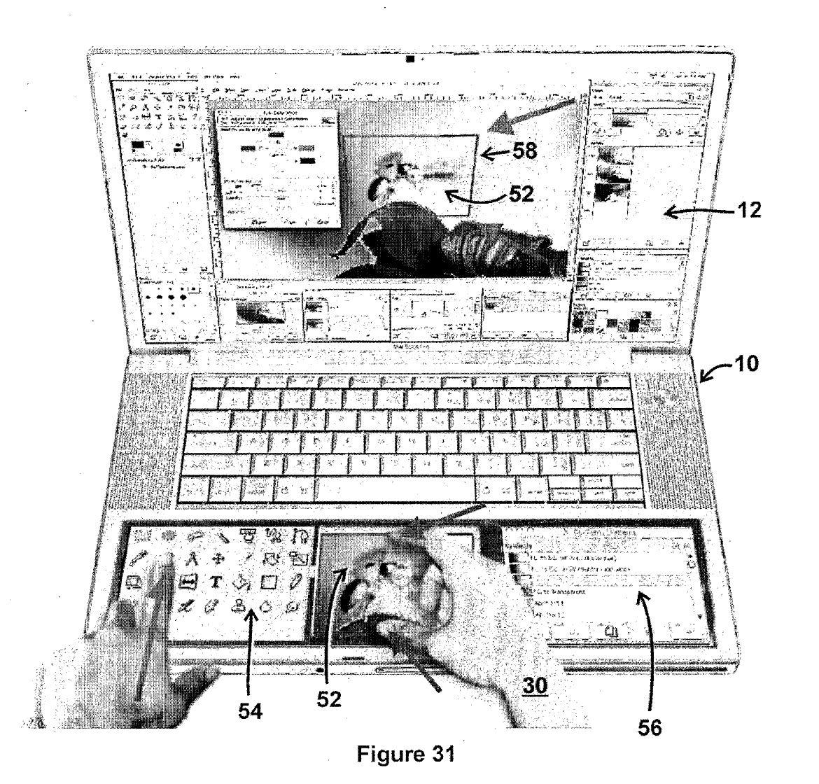

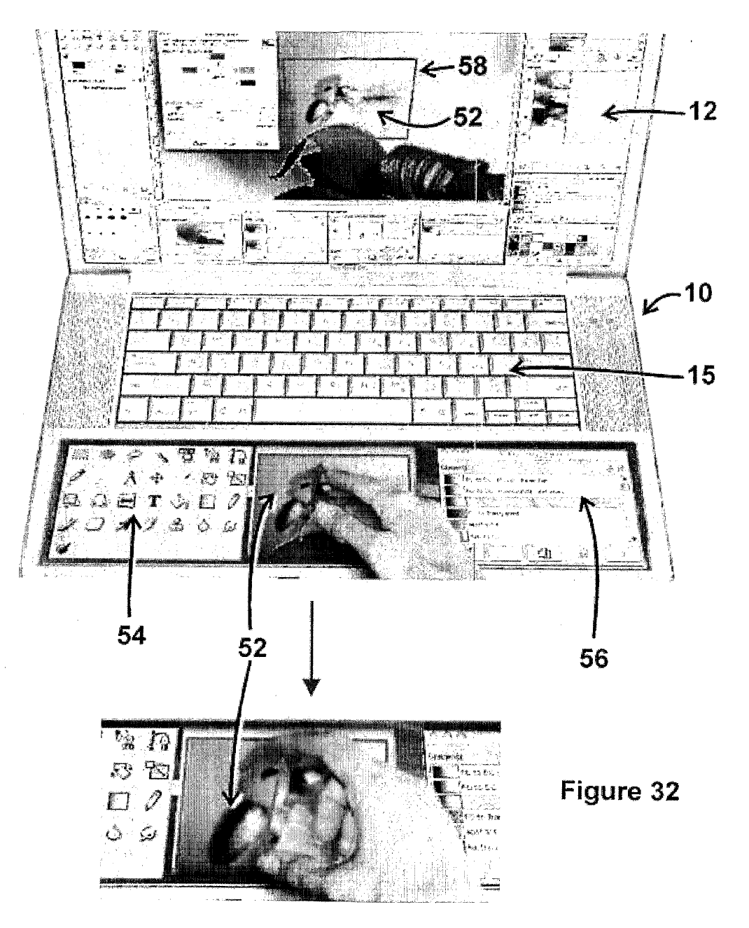

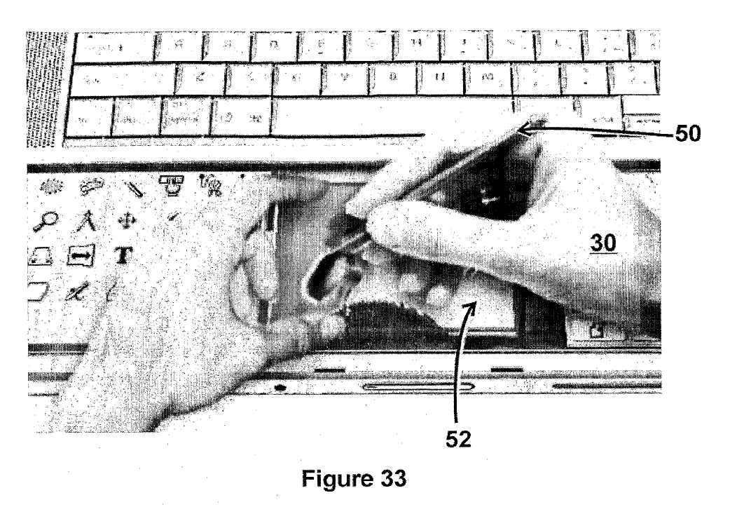

As described in the third example above (FIG. 6), further demonstrations of ways in which this user interface can be used are shown in FIGS. 30 to 33. For purposes of this demonstration, the software Photoshop® is used. When a user 30 touches the virtual touchpad 24 area with two fingers on opposed points, the program reacts by selecting the zoom function and displaying the photo 52 or part thereof in the place of the virtual touchpad 24. Areas 54 and 56 to the left and right of the photo 52 display options of the program relevant to the zoom function, which options can be selected by touch and gestures by the user 30. By moving the two fingers of the users towards each other (FIG. 31) the program zooms in and by moving the fingers away (FIG. 32) from each other, the program zooms in on the photo 52. The relevant zoom area is displayed within a rectangle 58 on the primary display. For pinpoint and fine detail manipulation of the photo 52 the user 30 can use a stylus 50 on the multi-touch display (FIG. 33).

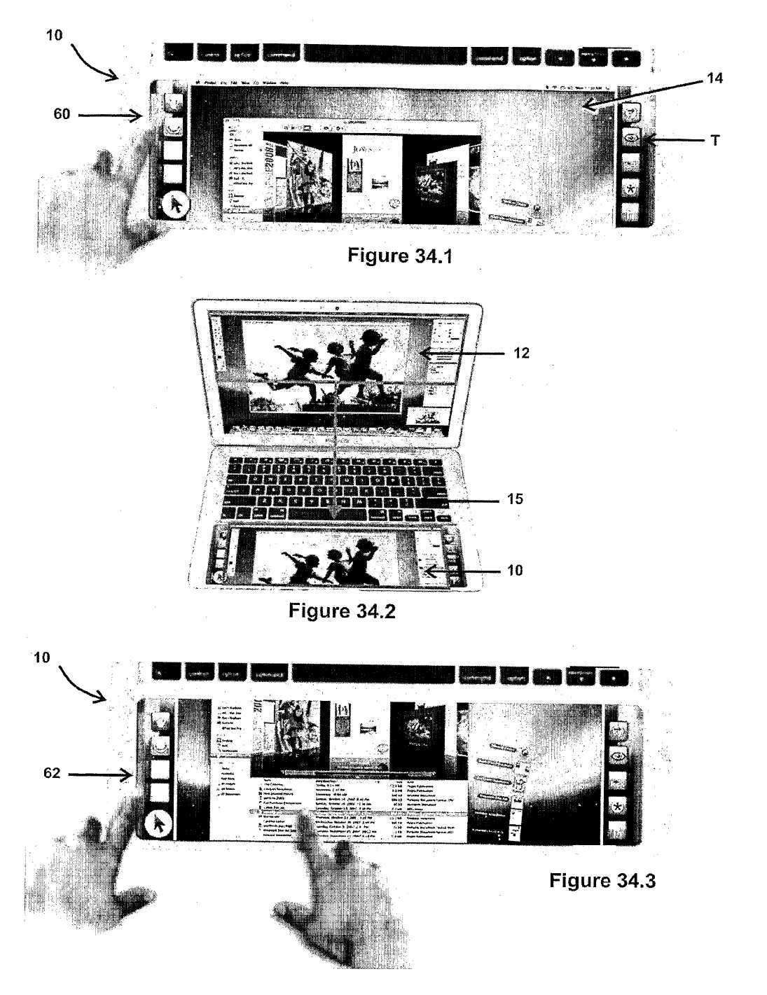

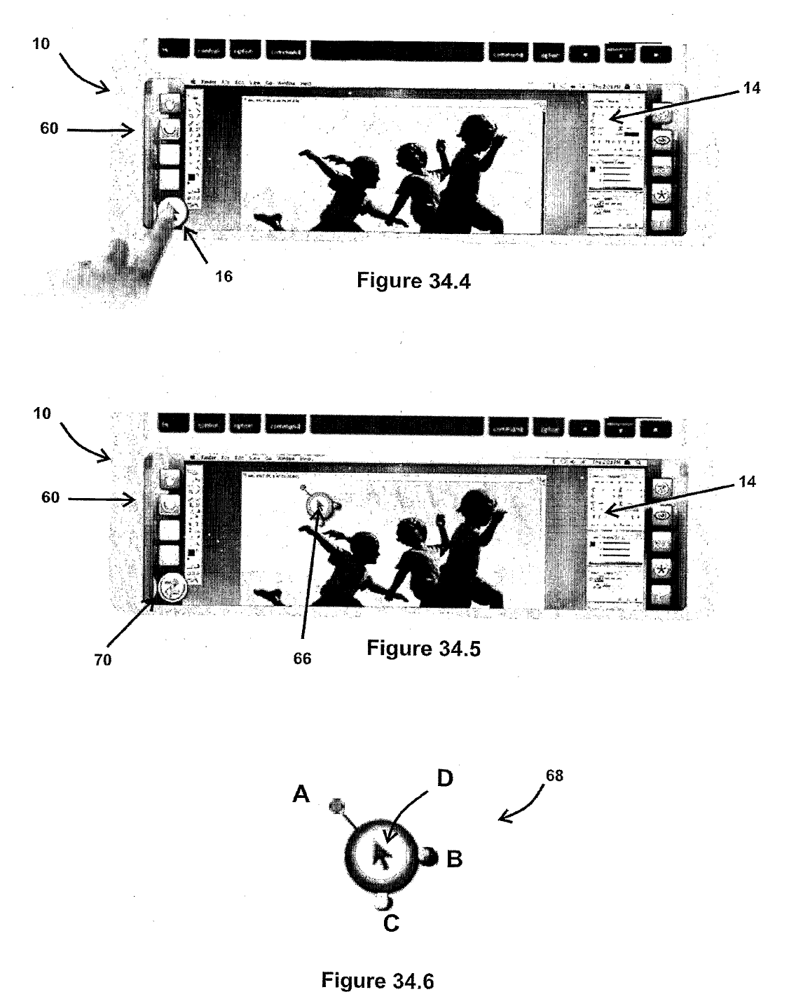

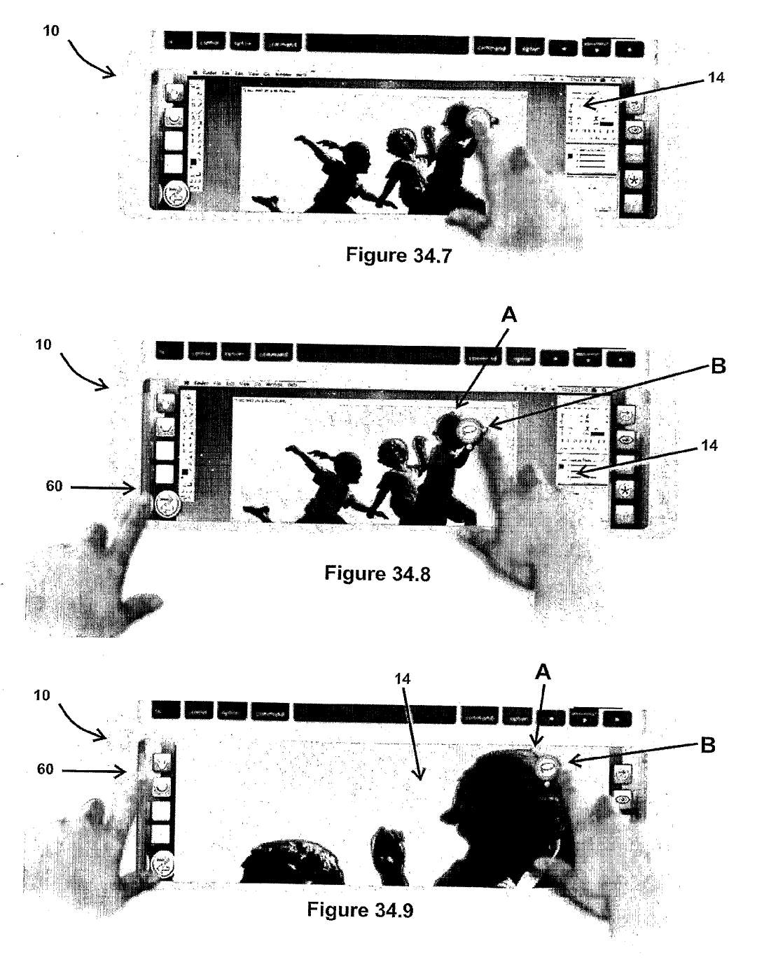

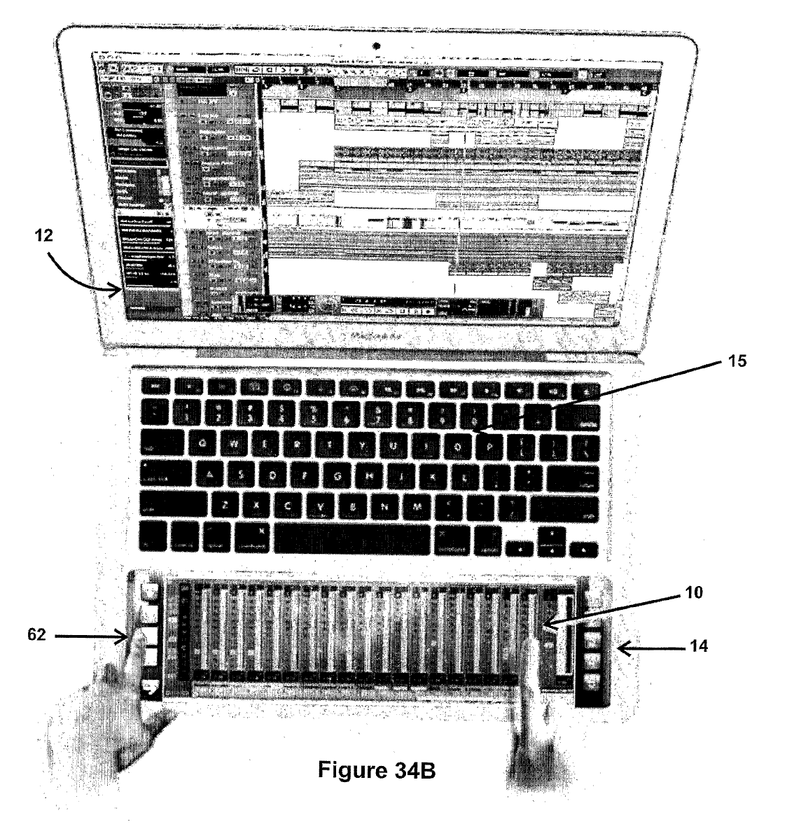

Further demonstrations of ways in which this user interface can be used are shown in FIGS. 34.1 to 34.9. The user interface includes a touch-sensitive display 10 in the form of a secondary multi-touch display to be used together with the primary display 12 and a Standard QWERTY keyboard 15. The secondary multi-touch display 10 is activated to display a live view mode by activating a live view icon 60. In the live view mode, the primary display drops down to the secondary display to allow a user to directly interact with it. A primary display slider 62 allows certain functions to be selected and for this view to be scrolled on the secondary display 10, which is smaller than the primary display Further, there is provided a finger pointing and interaction tool 68 by activating a cursor switch icon 70. This tool is a software assisted touch tool to enable precise pointing despite the size of a person's fingers which make detailed interaction difficult. This tool includes graphic indicia A to D, which include a target point A. The target point A is slightly removed from the actual contact point of a person's finger to be visible. The graphic indicia further include shortcut keys such as a zoom function C and a tool select key B. The indicia further include an active display zone D for displaying which type of tool or function is in use. This tool is programmed to float under a person's finger and can be used for precise pointing application without the need of a track ball, mouse, stylus or the like pointing device. The target point and zoom function can be used for detailed work. In FIGS. 34.8 and 34.9 the user selects the active zoom shortcut key (B) and slide the interactive slider (60) upwards to zoom into the image on the display screen. The image zooms closer and uses the active point (A) as reference. This allows the user to work in fine detail on the multi-touch display and keep an overview on the main LCD screen.

As shown in FIGS. 35 to 39, the user interface may include a set of transparent keys 74, which, in one state, protrude upward through openings in a smooth surface 72 to be discernable by a user as distinct keys, when a QWERTY keyboard, for example, is in use and/or displayed on the secondary display, and which keys are configured to retract to be flush with the surface, forming a smooth surface so as to present a single smooth user interface surface when the QWERTY keyboard is not in use or displayed. The user inter face may therefore include a set of keys which are configured to be raised above the surface of the secondary display 10. Typically a top layer 76 of transparent material will be provided with openings for receiving keys there through and lower layer 78 of transparent material provided with complementary raised keys with the two layers configured to be placed on a multi-touch display with the two layers being able to switch from a key protruding state to a no protruding state. In another embodiment, the lower layer 76 may comprise of strips 80, which strips can be independently switched or depressed to provide a person with a tactile response.

A further demonstration of how this user interface can be used is shown in FIG. 34B. The user interface includes a touch-sensitive display 10 in the form of a secondary multi-touch display to be used together with the primary display 12 and a Standard QWERTY keyboard 15. The secondary multi-touch display 10 is activated to display a dedicated controller screen 70 for an application displayed on the primary display 12, an audio mixer application in this case. All the controls are now accessible by means of virtual controller in stead of a dedicated hardware plug-in.

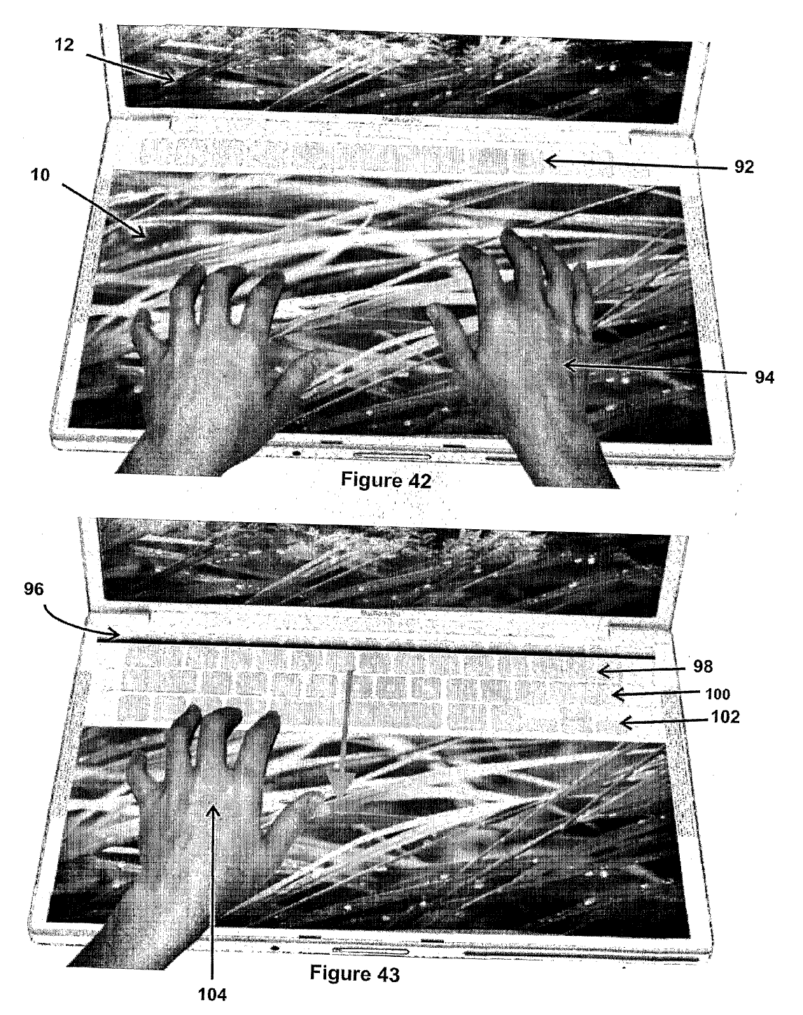

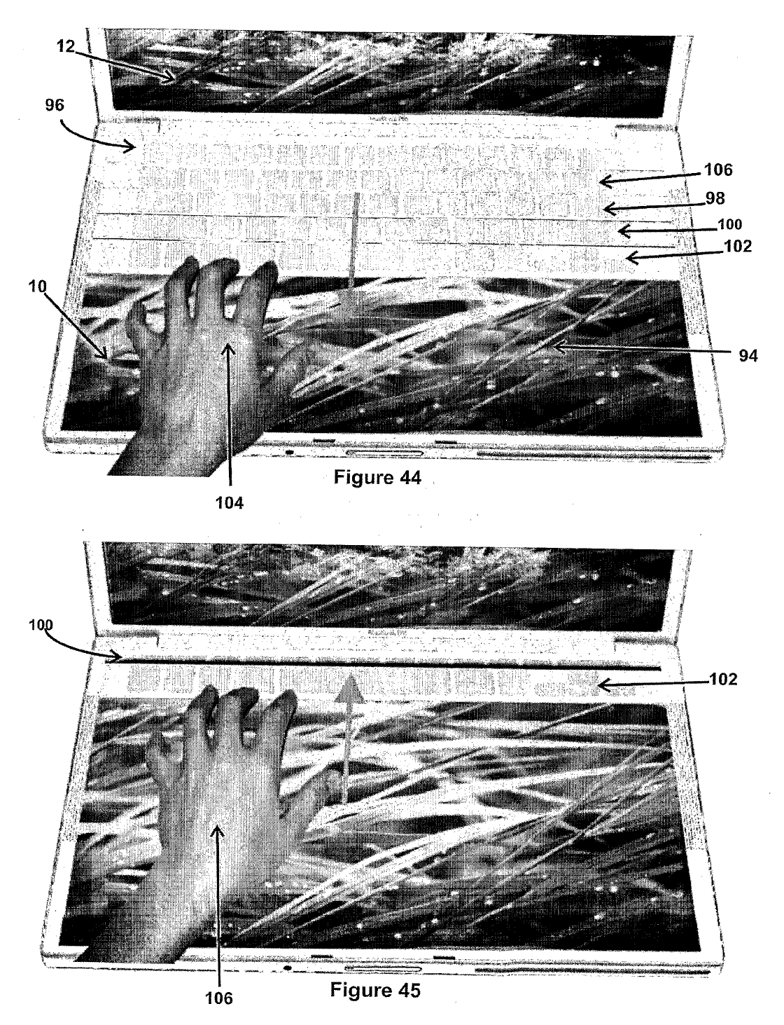

An example of providing a tactile response is shown in FIGS. 40-45. A void 86 or recess is located between the QWERTY keyboard and the base of the primary LCD screen 12 as shown in FIG. 40. The dimensions of this void allow for the stacking of individual strips looking similar to Strip 88 in FIG. 41. Each strip contains individual keys that reside on the strip (FIG. 41, Key 90). Each key can be independently depressed to provide a person with a tactile response when the QWERTY keyboard is in use and each key can send a unique electronic signal when depressed. Combining these strips in rows (FIG. 44, Strip 96, 98, 100, 102 & 106) will form a computer QWERTY keyboard. FIG. 42 shows the data processing machine (10) in full multi-touch mode where the user can interact with the complete seamless touch surface. When the QWERTY keyboard is needed for input, the user slides strips 92 (FIG. 42) away from the base of the Main LCD Screen (12). FIG. 43 shows the user's hand (104) sliding the keyboard onto the multi-touch display area. Each strip is equipped with a hooking mechanism that latches onto the next strip residing below in the void. This system ensures that each strip is pulled from the void onto the rails fitted in the base. FIG. 44 shows the complete strip assembly forming a QWERTY keyboard. When the user wants to use the full multi-touch surface (10), FIG. 45 shows how the strips are dropped back into the void with the last strip (102) ending at the top.

One example of applying the invention for an information searching or filtering application adapted to be implemented on the user interface in accordance with the invention, as shown in FIGS. 46.1 to 46.12, use can be made of the MSR 14.1 which is located above the usual F keys 16. Typically when an icon for a searching facility is selected from the normal operating system menu, the operating system menu jumps to the primary display 12 to make room for the search facility menu, which is in the form of main finder ribbon or dial of icons on the left rotating in a vertical direction, while the sub menu for each icon on the main ribbon or dial is represented to the right of the main ribbon or dial in the form of second horizontal ribbon of secondary icons. The primary set of icons represents the main search classes with the secondary set of icons representing sub search classes thereof. In order to improve visibility, a user can also extend the primary ribbon or dial horizontally by dragging the divider bar to the left, while the second ribbon or dial is greyed out. Once the primary ribbon or dial is dragged back the left, the secondary ribbon or dial is activated. Further sub categories can be added as required while stacking the higher categories on the right. In complex search scenarios, the primary display can be used to provide a convenient search overview. This navigation system can also be applied for any of the other larger MSD's described herein, however, this navigation system is so effective that it works as good in the smaller of the MSD's

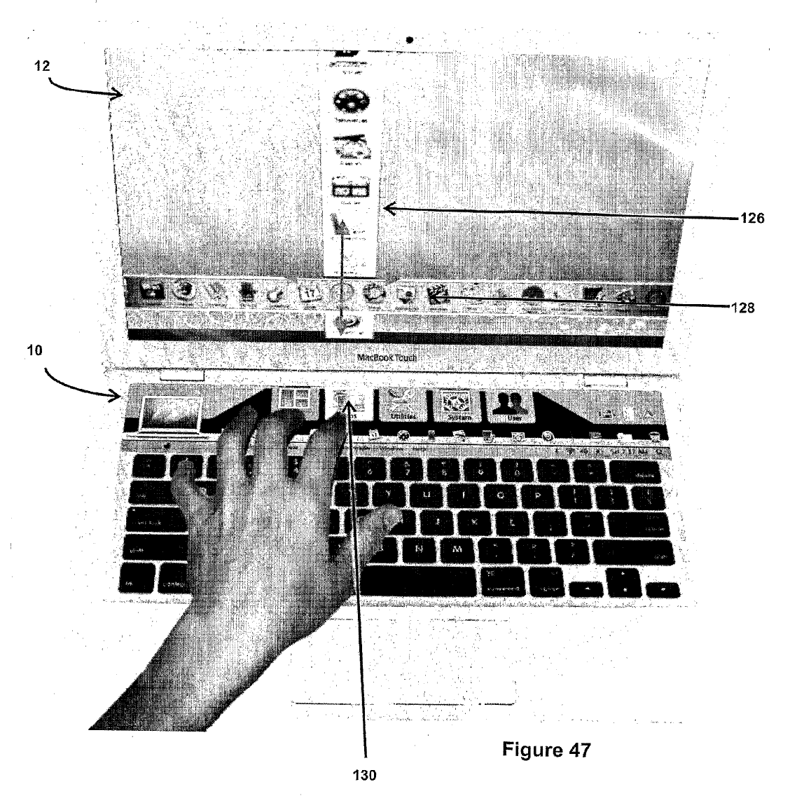

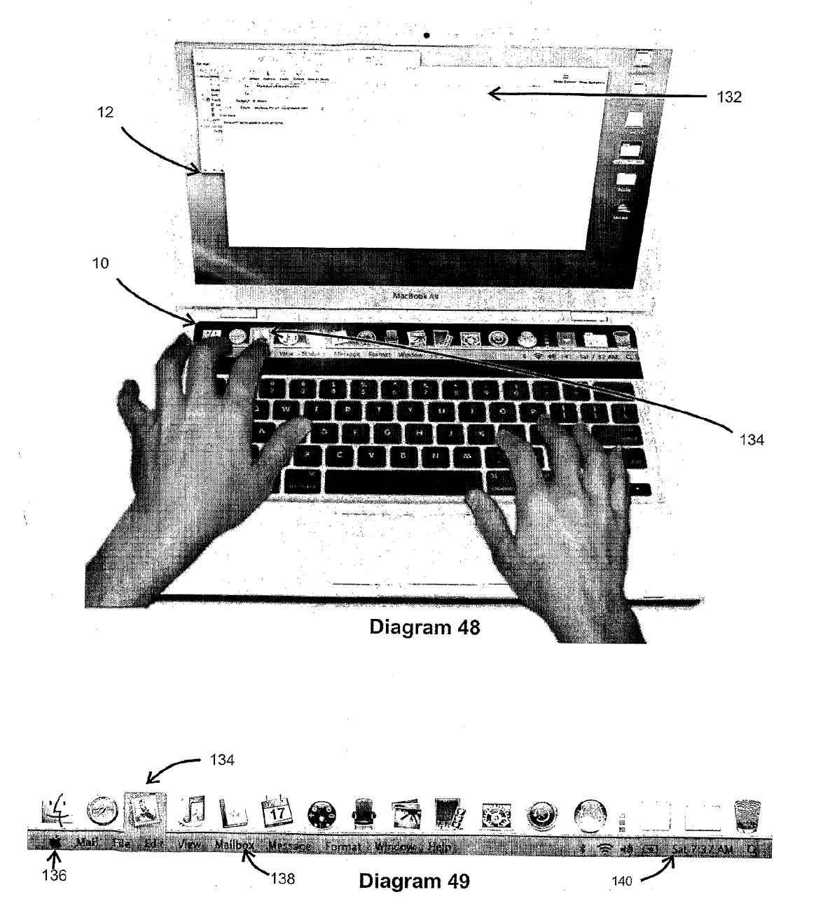

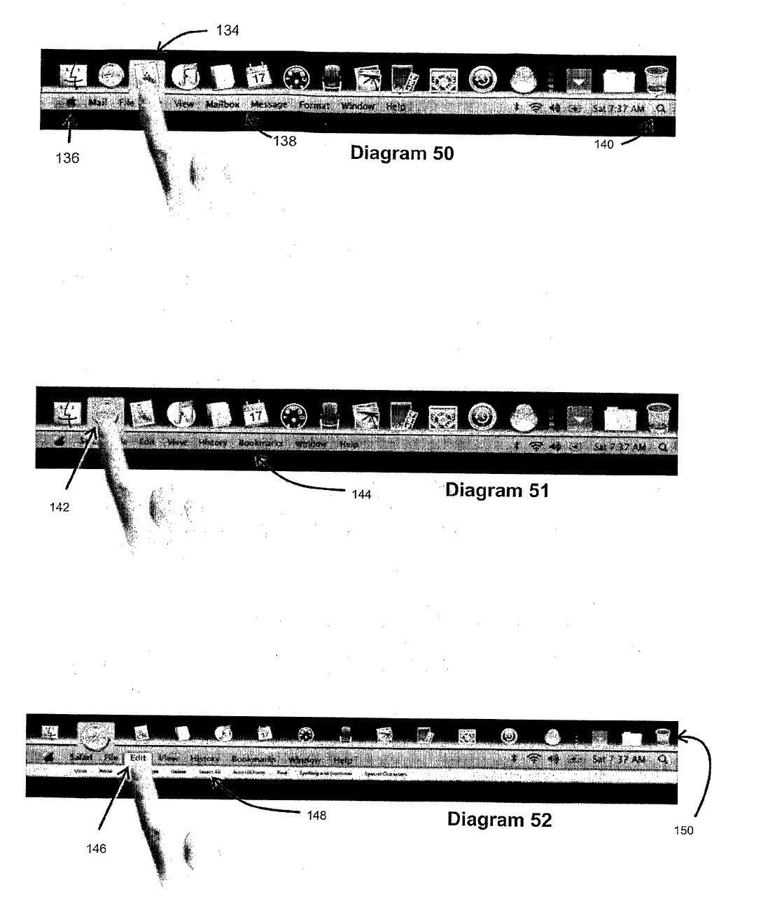

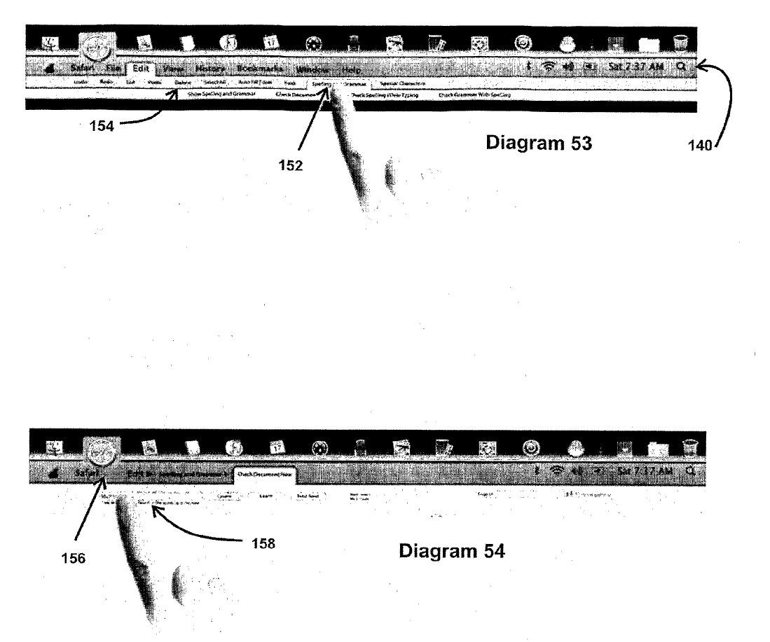

Another example of applying the invention for an information searching or filtering application adapted to be implemented on the user interface in accordance with the invention, as shown in FIG. 47, use can be made of the MSR 14.1 which is located above the usual F keys 16. When an icon for a searching facility is selected from the normal operating system menu, a vertical sub menu 126 may be shown the primary display 12. This sub menu 126 can be scrolled by up-down gestures on the MSR 14.1. When an icon from the sub menu 126 is in an active area it can be selected a further vertical submenu 128 is shown on the primary display 12, which can also be scrolled by left-right gestures. Further submenus can be stacked in the same way and it will be appreciated that the user can have a quick way to navigate menus with a good overview, only using one finger. This navigation system can also be applied for any of the other larger MSD's described herein, however, this navigation system is so effective that it works as good in the smaller of the MSD's

Another example of applying the invention for a tabbed menu driven application adapted to be implemented on the user interface in accordance with the invention, as shown in Diagrams 48 to 54, use can be made of the MSR 14.1 which is located above the usual F keys 16. When an application 132 is opened by selecting an icon 134, a main menu ribbon 138 is displayed below the Operating System icon ribbon. When one of the main menu items 146 are selected a further sub menu 148 opens below, and so forth. Importantly, the operating system is configured to shrink the upper Operating System menu to make space on the MSR 14.1 which have limited space, while still allowing any of the menu items or icons to be activated by a person and providing a full overview of the menus. When a sub menu item 152 is selected which take up significant space, the upper menus may be removed to make space. This navigation system can also be applied for any of the other larger MSD's described herein, however, this navigation system is so effective that it works as good in the smaller of the MSD's

It is apparent that the invention allows several new and inventive ways for a user to interact with a data processing machine and further leads to new and inventive operating system and application software interaction as well as new and novel hardware.

It shall be understood that the examples are provided for illustrating the invention further and to assist a person skilled in the art with understanding the invention and are not meant to be construed as unduly limiting the reasonable scope of the invention.

What is claimed is:

1. A user interface for a data processing machine which user interface is combined with a primary display screen for the machine or which is configured to be used with a machine which usually includes a primary display screen, which user interface comprises:
a secondary touch-sensitive display screen which is configured to be an input device for the machine and configured such that the graphic display of the input device is configured to complement and operatively cooperate with the graphic display of the primary display screen.

2. A user interface as claimed in claim 1, wherein the touch-sensitive display screen is a multi-touch-sensitive display screen.

3. A user interface as claimed in claim 2, wherein the secondary display comprises more than one touch-sensitive display or more than one zone on a single touch-sensitive display, which display or zone has a dedicated or preferred input function.

4. A user interface as claimed in claim 3, which comprises, in any combination:
a top touch-sensitive display or zone in the form of a strip to be used parallel to the primary display, in use, and located between the position usually occupied by a QWERTY keyboard and the bottom of the primary display of a data processing machine;
a middle touch-sensitive display or touch-sensitive display zone in the form of a strip to be used parallel to the primary display, in use, and located in the position usually occupied by a QWERTY keyboard; and
a bottom touch-sensitive display or touch-sensitive display zone in the form of a strip to be used parallel to the primary display, in use, and located between the position usually occupied by a QWERTY keyboard and the user of a data processing machine.

5. A user interface as claimed in claim 1, which comprises a video signal connection and/or communication means with a data processing machine and a user interface connection and/or communication means with the data processing machine.

6. A user interface as claimed in claim 4, which is configured to produce an audible cue to accompany a touch or gesture on the user interface.

7. A user interface as claimed in claim 4, wherein the middle interface comprise a set of transparent keys, which, in one state, protrude upward through openings in a smooth surface to be discernable by a user as distinct keys, when a keyboard is in use and/or displayed on the secondary display, and which keys are configured to retract to be flush with the surface, forming a smooth surface so as to present a single smooth user interface surface when the QWERTY keyboard is not in use or displayed.

8. A user interface as claimed in claim 7, wherein the lower layer comprises of strips, which strips can be independently depressed to provide a person with a tactile response.

9. A user interface as claimed in claim 7, wherein a virtual keyboard is displayed on the secondary middle display or touch-sensitive display zone.

10. A user interface as claimed in claim 4, wherein a virtual touchpad will be displayed over the secondary bottom display or touch-sensitive display zone.

11. A user interface as claimed in claim 4, which comprises sensors for detecting the position of a user's hands to float a virtual keyboard and/or virtual touch pad in relation to the positions of a user's hands.

12. A user interface as claimed in claim 4, wherein the user interface comprises more than one touch-sensitive display or touch-sensitive display zone, which complement and/or and operatively cooperate with each other.

13. A user interface as claimed in claim 4, which comprises three touch-sensitive display zones combined in a single touch-sensitive display in the form of a multi-touch display to be used together with the primary display.

14. A user interface as claimed in claim 13, which is configured to display a virtual hardware input device.

15. A user interface as claimed in claim 13, which is configured to display a special character screen by activating a special character icon.

16. A user interface as claimed in claim 13, which is configured to display a live view mode by activating a live view icon.

17. A user interface as claimed in claim 13, which is configured to display any one of a series of keyboard sets by activating a keyboard control dock which displays an icon for each keyboard in the set.

18. A user interface as claimed in claim 13, which is configured to interactively display a finger pointing and interaction tool by activating or scrolling a cursor switch icon.

19. A user interface as claimed in claim 13, which is configured to interactively display a relevant controller screen for an active application by activating an active program icon.

20. A user interface as claimed in claim 19, which is configured to interactively display a secondary set of contextual function icons which is relevant to the selected controller screen.

21. A user interface as claimed in claim 13, which is configured to interactively display a user defined set of controllers screens by activating a user set icon.

22. A user interface as claimed in claim 4, wherein the interface comprise a set of transparent strips, forming a smooth surface so as to present a single smooth user interface surface when the QWERTY keyboard is not in use or displayed, which strips can be independently depressed to provide a person with a tactile response when the QWERTY keyboard is in use or displayed.

23. A user interface as claimed in claim 22, wherein a virtual keyboard is displayed on the secondary middle display or touch-sensitive display zone in order to align the displayed virtual keyboard with the transparent strips.

24. A user interface as claimed in claim 22, wherein a virtual keyboard is divided into six rows of strips each being a middle display or touch-sensitive display zone in order to show a combined view of a QWERTY keyboard, which strips can be independently depressed to provide a person with a tactile response when the QWERTY keyboard is in use or displayed.

25. A user interface as claimed in claim 4, wherein the interface comprise a set of strips, each containing individual keys that reside on the strips to form a QWERTY keyboard, wherein each key can be independently depressed to provide a person with a tactile response when the QWERTY keyboard is in use, wherein each key can send an unique electronic signal when depressed.

26. A user interface as claimed in claim 25, wherein each strip resides in two rails that allow the strips to be moved forward and backward relevant to the primary display, wherein each strip is interconnected with the strips to the front and back of the mentioned strip by way of a hook mechanism.

27. A user interface as claimed in claim 26, wherein each strip can drop into a recessed deposit void when moved on the rails to the position of the void, wherein each strip can be pulled out of the void area when the strips are moved away from the void area, wherein each strip catches on the strip below in the void area by way of a hook.

28. A user interface as claimed in claim 27, wherein the last strip pulled out of the void also closes the top of the void.

29. A user interface as claimed in claim 25, wherein a virtual keyboard is displayed on the secondary middle display or touch-sensitive display zone, wherein the virtual keyboard is displayed to align with the individual keys residing on the strips to form a combined virtual QWERTY keyboard.

30. A user interface as claimed in claim 3, which comprises:
a top touch-sensitive display or zone in the form of a strip to be used parallel to the primary display, in use, and located between the position usually occupied by a QWERTY keyboard and the bottom of the primary display of a data processing machine, wherein an operating system is configured to display on the top touch-sensitive display or zone graphical horizontal and vertical menus, which can be scrolled be means of user gestures.

31. A user interface as claimed in claim 3, which comprises:
a top touch-sensitive display or zone in the form of a strip to be used parallel to the primary display, in use, and located between the position usually occupied by a QWERTY keyboard and the bottom of the primary display of a data processing machine, wherein an operating system is configured to display on the primary display graphically vertical and horizontal menus in ribbon form, in a stacked manner, which menus can be manipulated by a user by gestures on the a top touch-sensitive display or zone.

32. A user interface as claimed in claim 3, which comprises:
a top touch-sensitive display or zone in the form of a strip to be used parallel to the primary display, in use, and located between the position usually occupied by a QWERTY keyboard and the bottom of the primary display of a data processing machine, wherein an operating system is configured to display on the top touch-sensitive display or zone a tabbed menu system of an application by adding submenus to the bottom and shrinking an upper, graphical, operating system menu.

33. An operating system for operating a user interface as claimed in claim 1, which operating system is adapted or configured by means of software to provide the functionality of the user interface.
